(19) United States
(12) Patent Application Publication
(10) Pub. No.: US 2022/0205888 A1
(43) Pub. Date: Jun. 30, 2022

(54) ELLIPTICAL MATERIAL TESTING APPARATUS

(71) Applicant: LOON LLC, Mountain View, CA (US)

(72) Inventors: Venkata Akula, Mountain View, CA (US); Kyle Brookes, Redwood City, CA (US)

(21) Appl. No.: 17/135,426

(22) Filed: Dec. 28, 2020

(51) Int. Cl. G01N 3/10; G01B 13/24

(52) U.S. Cl. CPC G01N 3/10; G01B 13/24; G01N 2203/0282; G01N 2203/0254; G01N 2203/0044; G01N 2203/0222; G01N 2203/023; G01N 2203/0017

(57) ABSTRACT

Aspects of the technology relate to an apparatus and method for testing a material for use in a lighter-than-air craft deployable in the stratosphere. The apparatus and method may include and use a base plate and at least one ring component to attach to the base plate to secure a portion of the material. The at least one ring component has an elliptical shape including a minor radius having a first predetermined length and a major radius having a second predetermined length. The base plate receives a gas to inflate and pressurize the portion of the material. The first predetermined length and second predetermined length are selected to impart a stress ratio up to a predetermined maximum ratio onto the portion of the material through a predetermined temperature range when the portion of the material is inflated to a predetermined pressure.

### BACKGROUND

High altitude platforms, such as lighter-than-air (LTA) crafts, have been proposed for use in various applications, such as providing telecommunications connectivity to remote locations or areas with limited networking infrastructure. In such applications, a given LTA craft may be deployed at high altitudes, such as in the stratosphere, for long durations, such as weeks, months or more. During such deployments, the LTA crafts are subjected to extreme temperatures and pressures. As such, the materials used for building and manufacturing the LTA crafts, such as the materials used to manufacture envelopes for balloons, dirigible/airships, or other types of LTA crafts need to be able to tolerate highly variable stresses such as wide-ranging temperatures and pressures that the materials will be subjected to when deployed for use in the stratosphere or elsewhere. It can be very difficult to test such materials in a manner that accurately recreates the conditions the materials will be subjected to when the LTA craft is deployed for use in the stratosphere.

### SUMMARY

Aspects of the technology relate to providing a materials testing apparatus and method for testing the stress state of materials used in the manufacture of envelopes used with lighter-than-air (LTA) craft deployable in the stratosphere for long periods of time under various pressures and/or temperature conditions. The materials testing apparatus uses elliptically shaped fixture elements that are dimensioned to impart sufficiently high pressures onto material during testing to achieve a stress state needed to evaluate the material to ensure the material is suitable for use in deployment. While earlier systems exist for testing films, these systems are not suitable for testing materials subjected to high pressures and particular stress ratios throughout wide temperature ranges during use in LTA craft deployment. The elliptical shape and dimensions of the fixture elements in the materials testing apparatus described below improve upon prior testing systems because the shape and dimensions of the fixture elements in the materials testing apparatus correlate to generate the required stress ratio for testing materials throughout various temperature ranges and other conditions.

According to one aspect, an apparatus is provided for testing a material for use in a lighter-than-air craft deployable in the stratosphere. The apparatus comprises a base plate and at least one ring component configured to attach to the base plate to secure a portion of the material during testing. The at least one ring component has an elliptical shape. The elliptical shape includes a minor radius having a first predetermined length and a major radius having a second predetermined length. The base plate is configured to receive gas to inflate and pressurize the portion of the material secured by the at least one ring component. The first predetermined length and second predetermined length are selected to impart a stress ratio up to a predetermined maximum ratio onto the portion of the material secured by the at least one ring component through a predetermined temperature range when the portion of the material is inflated to a predetermined pressure.

In one example, the first predetermined length is approximately 0.35 meters and the second predetermined length is approximately 0.4 meters. In another example, the material includes warp and weft directions and the first predetermined length and the second predetermined length are selected based on strength limits in the warp and weft directions, respectively, of the material.

In a further example, the predetermined maximum ratio is a ratio between a strength limit of the material in a first direction of the material and a strength limit of the material in a second direction of the material. In this case, the first direction may be a warp direction of the material and the second direction may be a weft direction of the material.

In yet another example, the predetermined maximum ratio is approximately 2:1. Alternatively, the predetermined maximum ratio may correspond to a stress state that the lighter-than-air craft is subjected to during deployment.

The predetermined temperature range may correspond to a temperature range the lighter-than-air craft is expected to be exposed to during deployment. For instance, the predetermined temperature range may be between −40 Celsius to 22 Celsius.

The at least one ring component may comprise first and second gaskets, and the portion of the material is compressed between the first and second gaskets to prevent leakage of the gas inflating and pressurizing the portion of the material. Here, the at least one ring component may further comprise an elliptical ring configured to attach the first and second gaskets to the base plate. Alternatively or additionally, the apparatus further comprises a containment plate attached to and disposed a predetermined distance from the at least one ring component and opposite the base plate.

According to another aspect of the technology, a method is provided for testing a material for use in a lighter-than-air craft deployable in the stratosphere. The method comprises providing a base plate of a materials testing apparatus; providing at least one ring component of the materials testing apparatus that has an elliptical shape, the elliptical shape including a minor radius having a first predetermined length and a major radius having a second predetermined length; attaching the at least one ring component to the base plate to secure a portion of the material therebetween; receiving, by the base plate, a gas from a gas source to inflate the portion of the material to a predetermined pressure; subjecting the portion of the material to a predetermined temperature range commensurate with operation in the stratosphere, wherein the first predetermined length and second predetermined length are selected to impart a stress ratio up to a predetermined maximum ratio onto the portion of the material secured by the at least one ring component through the predetermined temperature range when the portion of the material is inflated to the predetermined pressure; and measuring a stress state of the portion of the material.

In one example, the first predetermined length is approximately 0.35 meters and the second predetermined length is approximately 0.4 meters. In another example, the material includes warp and weft directions and the first predetermined length and the second predetermined length are selected based on strength limits in the warp and weft directions, respectively, of the material.

In a further example, the predetermined maximum ratio is a ratio between a strength limit of the material in a first direction of the material and a strength limit of the material in a second direction of the material. In this case, the first direction may be a warp direction of the material and the second direction may be a weft direction of the material.

In another example, the predetermined maximum ratio is approximately 2:1. In a further example, the predetermined maximum ratio corresponds to a stress state that the lighter-than-air craft is subjected to during deployment.

The predetermined temperature range may correspond to a temperature range the lighter-than-air craft is exposed to during deployment. For example, the predetermined temperature range may be between −40 Celsius to 22 Celsius.

In yet another example, the at least one ring component comprises first and second gaskets and the portion of the material is compressed between the first and second gaskets to prevent leakage of the gas inflating and pressurizing the portion of the material. Here, the at least one ring component may further comprise an elliptical ring configured to attach the first and second gaskets to the base plate.

The method may further comprise attaching a containment plate to the materials testing apparatus so that the containment plate is disposed a predetermined distance from the at least one ring component and opposite the base plate.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a functional diagram of an example system in accordance with aspects of the disclosure.

FIGS. 2A-B illustrates lighter-than-air platform configurations in accordance with aspects of the disclosure.

FIG. 3 is an example payload arrangement in accordance with aspects of the disclosure.

FIGS. 4 and 5 illustrate an example materials testing apparatus in accordance with aspects of the present technology.

FIGS. 6A and 6B illustrate a component of the materials testing apparatus of FIGS. 4 and 5 in accordance with aspects of the present technology.

FIG. 7 illustrates another component of the materials testing apparatus of FIGS. 4 and 5 in accordance with aspects of the present technology.

FIG. 8 illustrates the testing apparatus of FIGS. 4 and 5 with a containment plate of the apparatus removed in accordance with aspects of the present technology.

FIG. 9 illustrates a detailed view of a portion of the materials testing apparatus of FIGS. 4 and 5 in accordance with aspects of the present technology.

FIG. 10 illustrates the materials testing apparatus of FIGS. 4 and 5 being used in a temperature-controlled environment to test a material in accordance with aspects of the present technology.

FIG. 11 illustrates a stress analysis of a portion of a light-than-air craft in accordance with aspects of the present technology.

FIG. 12 illustrates a chart associated with the stress analysis of FIG. 11 in accordance with aspects of the present technology.

FIGS. 13A-15E illustrate results of experiments performed under various conditions during use of the materials testing apparatus of FIGS. 4 and 5 in accordance with aspects of the present technology.

FIGS. 16A-16D illustrate material analysis of several components of the materials testing apparatus of FIGS. 4 and 5 in accordance with aspects of the present technology.

FIG. 17 illustrates an example method of operation in accordance with aspects of the present technology.

### DETAILED DESCRIPTION

### Overview

The technology relates to providing a materials testing apparatus and method for testing the stress state of materials used in the manufacture of envelopes used with lighter-than-air (LTA) craft deployable in the stratosphere for long periods of time under various pressures and/or temperature conditions. As described below, the materials testing apparatus uses elliptically shaped fixture elements that are dimensioned to impart sufficiently high pressures onto the material during testing to achieve a stress state needed to evaluate the material to ensure the material is suitable for use in deployment. While earlier systems exist for testing films, these systems may not be suitable for testing materials subjected to high pressures and particular stress ratios throughout wide temperature ranges during use in LTA craft deployment. The elliptical shape and dimensions of the fixture elements in the materials testing apparatus described herein improve upon prior testing systems because the shape and dimensions of the fixture element in the materials testing apparatus correlate to generate required stress ratios for testing the material throughout various temperature ranges and other conditions.

### Example Balloon Systems

Fig. depicts an example system 100 in which a fleet of high-altitude platforms (HAPs), including LTA platforms and other platforms, may be used. This example should not be considered as limiting the scope of the disclosure or usefulness of the features described herein. System 100 may be considered an LTA-based network. In this example, network 100 includes a plurality of devices, such as HAPs 102A-F as well as ground-base stations 106 and 112. System 100 may also include a plurality of additional devices, such as various computing devices (not shown) as discussed in more detail below or other systems that may participate in the network.

The devices in system 100 are configured to communicate with one another. As an example, the HAPs may include communication links 104 and/or 114 in order to facilitate intra-balloon communications. By way of example, links 114 may employ radio frequency (RF) signals, such as millimeter wave transmissions, while links 104 employ free-space optical transmission. Alternatively, all links may be RF, optical, or a hybrid that employs both RF and optical transmission. In this way, HAPs 102A-F may collectively function as a mesh network for data communications. At least some of the HAPs 102A-F may be configured for communications with ground-based stations 106 and 112 via respective links 108 and 110, which may be RF and/or optical links.

In one scenario, a given HAP 102 may be configured to transmit an optical signal via an optical link 104. Here, the given HAP 102 may use one or more high-power light-emitting diodes (LEDs) to transmit an optical signal. Alternatively, some or all of the HAP 102 may include laser systems for free-space optical communications over the optical links 104. Other types of free-space communication are possible. Further, in order to receive an optical signal from another HAP 102 via an optical link 104, the HAP 102 may include one or more optical receivers.

The HAPs 102 may also utilize one or more of various RF air-interface protocols for communication with ground-based stations via respective communication links. For instance, some or all of the HAPs 102A-F may be configured to communicate with ground-based stations 106 and 112 via RF links 108 using various protocols described in IEEE 802.11 (including any of the IEEE 802.11 revisions), cellular protocols such as GSM, CDMA, UMTS, EV-DO, WiMAX, and/or LTE, 5G and/or one or more proprietary protocols developed for long distance communication, among other possibilities.

In some examples, the links may not provide a desired link capacity for HAP-to-ground communications. For instance, increased capacity may be desirable to provide backhaul links from a ground-based gateway. Accordingly, an example network may also include downlink HAPs, which could provide a high-capacity air-ground link between the various HAPs of the network and the ground-base stations. For example, in network 100, dirigible 102A or balloon 102B may be configured as a downlink HAP that directly communicates with station 106.

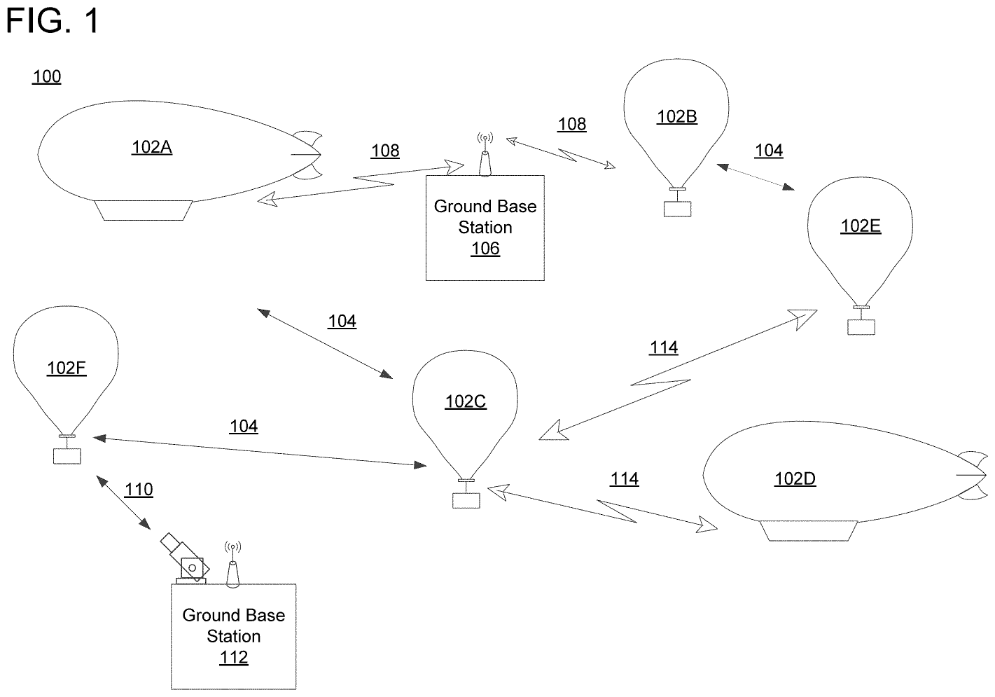

Like other HAPs in network 100, downlink HAP 102F may be operable for communication, such as RF or optical communication, with one or more other HAPs via link(s) 104. Downlink HAP 102F may also be configured for free-space optical communication with ground-based station 112 via an optical link 110. Optical link 110 may therefore serve as a high-capacity link (as compared to an RF link 108) between the network 100 and the ground-based station 112. Downlink HAP 102F may additionally be operable for RF communication with ground-based stations 106. In other cases, downlink HAP 102F may only use an optical link for balloon-to-ground communications. Further, while the arrangement shown in FIG. 1 includes just one downlink HAP 102F, an example balloon network can also include multiple downlink HAPs. On the other hand, a HAP network can also be implemented without any downlink HAPs.

A downlink HAP may be equipped with a specialized, high bandwidth RF communication system for balloon-to-ground communications, instead of, or in addition to, a free-space optical communication system. The high bandwidth RF communication system may take the form of an ultra-wideband system, which may provide an RF link with substantially the same capacity as one of the optical links 104.

In a further example, some or all of HAPs 102A-F could be configured to establish a communication link with space-based satellites and/or other types of non-LTA craft, such as drones, airplanes, etc., in addition to, or as an alternative to, a ground-based communication link. In some embodiments, a stratospheric HAP may communicate with a satellite or other high-altitude platform via an optical or RF link. However, other types of communication arrangements are possible.

As noted above, the HAPs 102A-F may collectively function as a mesh network. More specifically, since HAPs 102A-F may communicate with one another using free-space optical links, the HAPs may collectively function as a free-space optical mesh network. In a mesh-network configuration, each HAP may function as a node of the mesh network, which is operable to receive data directed to it and to route data to other HAPs. As such, data may be routed from a source HAP to a destination HAP by determining an appropriate sequence of links between the source HAP and the destination HAP.

The network topology may change as the HAPs move relative to one another and/or relative to the ground. Accordingly, the network 100 may apply a mesh protocol to update the state of the network as the topology of the network changes. For example, to address the mobility of the HAPs 102A to 102F, the balloon network 100 may employ and/or adapt various techniques that are employed in mobile ad hoc networks (MANETs). Other examples are possible as well.

Network 100 may also implement station-keeping functions using winds and altitude control and/or lateral propulsion to help provide a desired network topology, particularly for LTA platforms. For example, station-keeping may involve some or all of HAPs 102A-F maintaining and/or moving into a certain position relative to one or more other HAPs in the network (and possibly in a certain position relative to a ground-based station or service area). As part of this process, each HAP may implement station-keeping functions to determine its desired positioning within the desired topology, and if necessary, to determine how to move to and/or maintain the desired position. Alternatively, the platforms may be moved without regard to the position of their neighbors, for instance to enhance or otherwise adjust communication coverage at a particular geographic location.

The desired topology may thus vary depending upon the particular implementation and whether or not the HAPs are continuously moving. In some cases, HAPs may implement station-keeping to provide a substantially uniform topology where the HAPs function to position themselves at substantially the same distance (or within a certain range of distances) from adjacent balloons in the network 100. Alternatively, the network 100 may have a non-uniform topology where HAPs are distributed more or less densely in certain areas, for various reasons. As an example, to help meet the higher bandwidth demands, HAPs may be clustered more densely over areas with greater demand (such as urban areas) and less densely over areas with lesser demand (such as over large bodies of water). In addition, the topology of an example HAP network may be adaptable allowing HAPs to adjust their respective positioning in accordance with a change in the desired topology of the network.

The HAPs of FIG. 1 may be platforms that are deployed in the stratosphere. As an example, in a high-altitude network, the HAP platforms may generally be configured to operate at stratospheric altitudes, such as between 50,000 ft and 70,000 ft or more or less, in order to limit the HAPs' exposure to high winds and interference with commercial airplane flights. In order for the HAPs to provide a reliable mesh network in the stratosphere, where winds may affect the locations of the various HAPs in an asymmetrical manner, the HAPs may be configured to move latitudinally and/or longitudinally relative to one another by adjusting their respective altitudes, such that the wind carries the respective HAPs to the respectively desired locations. Lateral propulsion may also be employed to affect the balloon's path of travel.

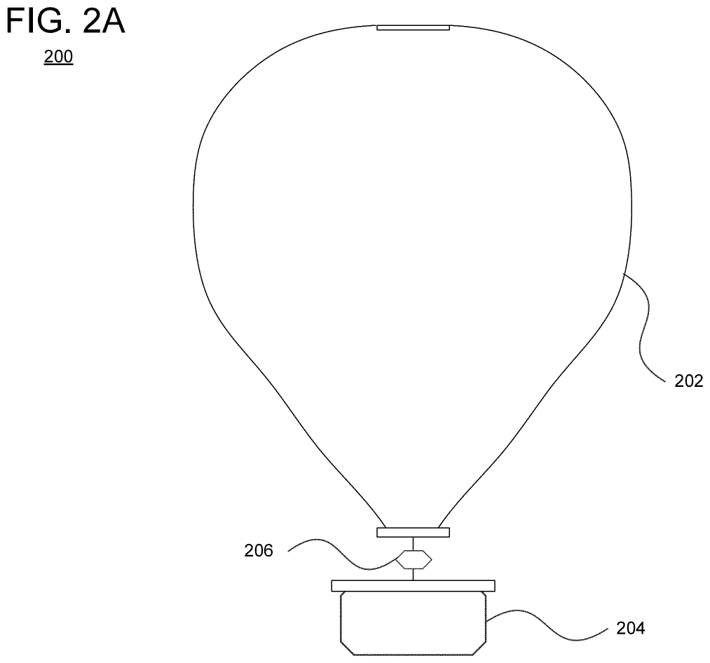

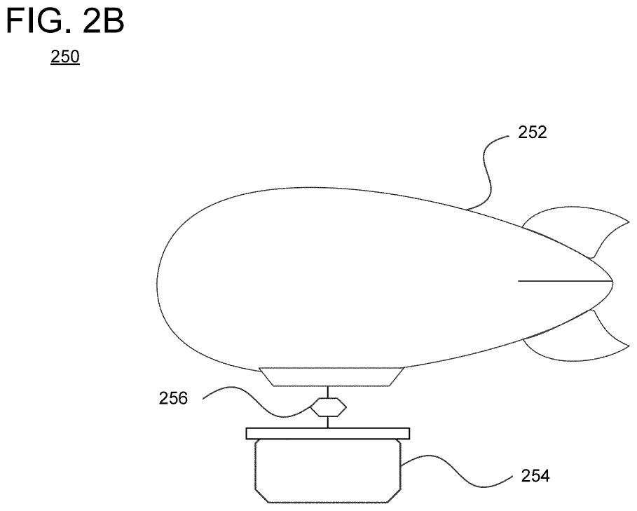

In an example configuration, the HAPs include an envelope and a payload, along with various other components. FIG. 2A is an example of a high-altitude balloon 200, which may represent any of the balloons of FIG. 1. As shown, the example balloon 200 includes an envelope 202, a payload 204 and a termination device 206 such a cut down and parachute. FIG. 2B is an example of a high-altitude dirigible or airship 250, which may represent any of the dirigibles of FIG. 1. As shown, the example airship 250 includes an envelope 252, a payload 254 and a termination device 256. The balloon 200 and airship 250 are examples of LTA craft or platforms.

The envelope 202 or 252 may take various shapes and forms. For instance, the envelope may be made of materials such as polyethylene, mylar, FEP, rubber, latex, fabrics, textiles, or other thin film materials or composite laminates of those materials with fiber reinforcements embedded inside or outside. Other materials or combinations thereof or laminations may also be employed to deliver required strength, gas barrier, RF and thermal properties. Furthermore, the shape and size of the envelope may vary depending upon the particular implementation. Additionally, the envelope may be filled with different types of gases, such as air, helium and/or hydrogen. Other types of gases, and combinations thereof, are possible as well. Shapes may include typical balloon shapes like spheres and “pumpkins”, or aerodynamic shapes that are symmetric, provide shaped lift, or are changeable in shape. Symmetric shapes may include a teardrop shape. Lift may come from lift gasses, electrostatic charging of conductive surfaces, aerodynamic lift (wing shapes), air moving devices (propellers, flapping wings, electrostatic propulsion, etc.) or any hybrid combination of lifting techniques. Lift gasses may include helium and hydrogen.

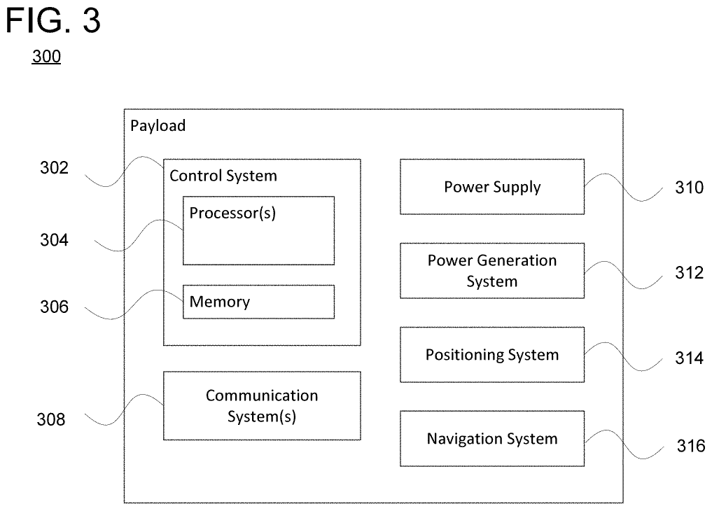

FIG. 3 provides an example of a payload 300 of a HAP platform which may correspond to payload 204 or 254. The payload 300 includes a control system 302 having one or more processors 304 and on-board data storage in the form of memory 306. Memory 306 stores information accessible by the processor(s) 304, including instructions that can be executed by the processors. The memory 306 also includes data that can be retrieved, manipulated or stored by the processor. The memory can be of any non-transitory type capable of storing information accessible by the processor, such as a hard-drive, memory card, ROM, RAM, and other types of write-capable, and read-only memories. The instructions can be any set of instructions to be executed directly, such as machine code, or indirectly, such as scripts, by the processor. In that regard, the terms “instructions,” “application,” “steps” and “programs” can be used interchangeably herein. The instructions can be stored in object code format for direct processing by the processor, or in any other computing device language including scripts or collections of independent source code modules that are interpreted on demand or compiled in advance. The data can be retrieved, stored or modified by the one or more processors 304 in accordance with the instructions.

The one or more processors 304 can include any conventional processors, such as a commercially available CPU. Alternatively, each processor can be a dedicated component such as an ASIC, controller, or other hardware-based processor. Although FIG. 3 functionally illustrates the processor(s) 304, memory 306, and other elements of control system 302 as being within the same block, the system can actually comprise multiple processors, computers, computing devices, and/or memories that may or may not be stored within the same physical housing. For example, the memory can be a hard drive or other storage media located in a housing different from that of control system 302. Accordingly, references to a processor, computer, computing device, or memory will be understood to include references to a collection of processors, computers, computing devices, or memories that may or may not operate in parallel.

The payload 300 may also include various other types of equipment and systems to provide a number of different functions. For example, as shown the payload 300 includes one or more communication systems 308, which may transmit signals via RF and/or optical links as discussed above. The communication system(s) 308 include communication components such as one or more transmitters and receivers (or transceivers), one or more antennae, and a baseband processing subsystem. (not shown)

The payload 300 is illustrated as also including a power supply 310 to supply power to the various components of the balloon. The power supply 310 could include one or more rechargeable batteries or other energy storage systems like capacitors or regenerative fuel cells. In addition, the balloon 300 may include a power generation system 312 in addition to or as part of the power supply. The power generation system 312 may include solar panels, stored energy (hot air), relative wind power generation, or differential atmospheric charging (not shown), or any combination thereof, and could be used to generate power that charges and/or is distributed by the power supply 310.

The payload 300 may additionally include a positioning system 314. The positioning system 314 could include, for example, a global positioning system (GPS), an inertial navigation system, and/or a star-tracking system. The positioning system 314 may additionally or alternatively include various motion sensors, such as accelerometers, magnetometers, gyroscopes, and/or compasses. The positioning system 314 may additionally or alternatively include one or more video and/or still cameras, and/or various sensors for capturing environmental data. Some or all of the components and systems within payload 300 may be implemented in a radiosonde or other probe, which may be operable to measure, for example, pressure, altitude, geographical position (latitude and longitude), temperature, relative humidity, and/or wind speed and/or wind direction, among other information. Wind sensors may include different types of components like pitot tubes, hot wire or ultrasonic anemometers or similar, windmill or other aerodynamic pressure sensors, laser/lidar, or other methods of measuring relative velocities or distant winds.

Payload 300 may include a navigation system 316 separate from, or partially or fully incorporated into control system 302. The navigation system 316 may implement station-keeping functions to maintain position within and/or move to a position in accordance with a desired topology or other service requirement. In particular, the navigation system 316 may use wind data to determine altitudinal and/or lateral positional adjustments that result in the wind carrying the balloon in a desired direction and/or to a desired location. The wind data may be received from onboard and/or remote sensors. The altitudinal and/or lateral adjustments may be computed by a central control location and transmitted by a ground based, air based, or satellite-based system and communicated to the HAP. In other embodiments, specific HAPs may be configured to compute altitudinal and/or lateral adjustments for other HAPs and transmit the adjustment commands to those other HAPs.

### Material Testing Apparatus

As described above, to ensure the stability and useful life of the materials used to manufacture certain portions of a balloon, dirigible, or other type of LTA craft, such as the envelopes 202, 252 described above, the materials should be tested under pressure and temperature conditions that the materials will experience during long duration deployment in the stratosphere. A materials testing apparatus may be used for testing materials under the pressure and temperature conditions the materials will experience during deployment of the LTA craft in the stratosphere.

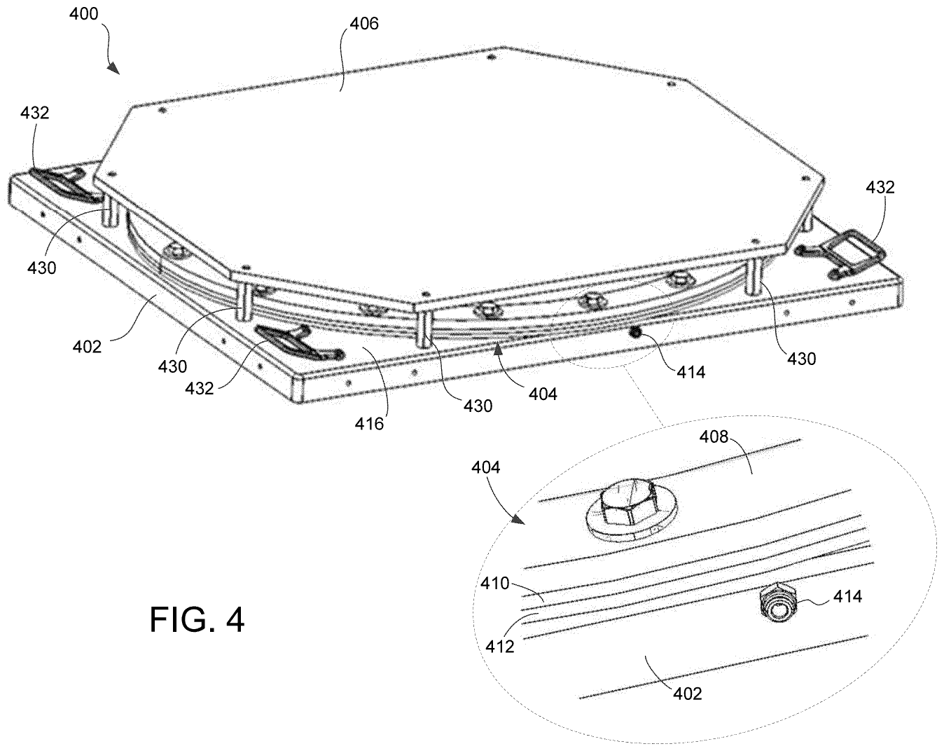

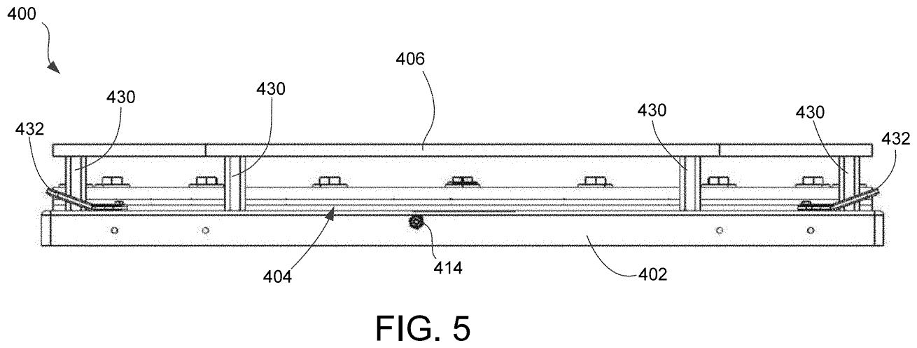

For example, referring to FIGS. 4 and 5, perspective and side views of an example materials testing apparatus 400 are shown. Materials testing apparatus 400 includes a base plate 402, an elliptical ring component assembly 404, a containment plate 406, and several securing elements, such as bolts, washers, screws, etc., for securing the elliptical ring component assembly 404 and the containment plate 406 to the base plate 402.

FIG. 4 shows a detailed view of elliptical ring component assembly 404. As shown in FIG. 4, the elliptical ring component assembly 404 may include a top plate 408, a first gasket 410, and a second gasket 412. The elliptical ring component assembly 404 is configured for securing and sealing a portion of a material used to manufacture an envelope, such as envelope 202 or 252, to base plate 402 so that the material may be tested using materials testing apparatus 400. Each of the top plate 408, first gasket 410, and second gasket 412 are configured as closed elliptical rings with predetermined major and minor radii, as will be described in greater detail below. In use, a portion of the material is placed or inserted between the first gasket 410 and second gaskets 412 with the second gasket 412 placed against a surface 416 of the base plate 402. Then, the top plate 408 is placed over the first gasket 410 and a plurality of securing elements are used to secure the top plate 408, first gasket 410, and second gasket 412 to surface 416 the base plate 402. In this arrangement, the material is compressed between the first gasket 410 and second gasket 412 and a portion of the material is secured and sealed. The plurality of securing element may include bolts, washers, screws, or other fasteners or elements suitable for securing top plate 408, first gasket 410, and second gasket 412 to surface 416 the base plate 402.

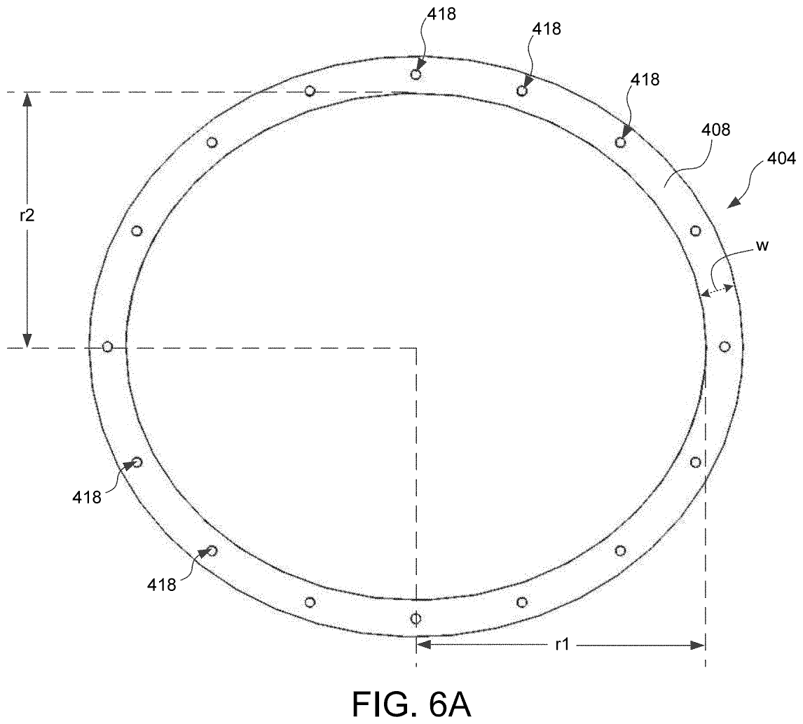

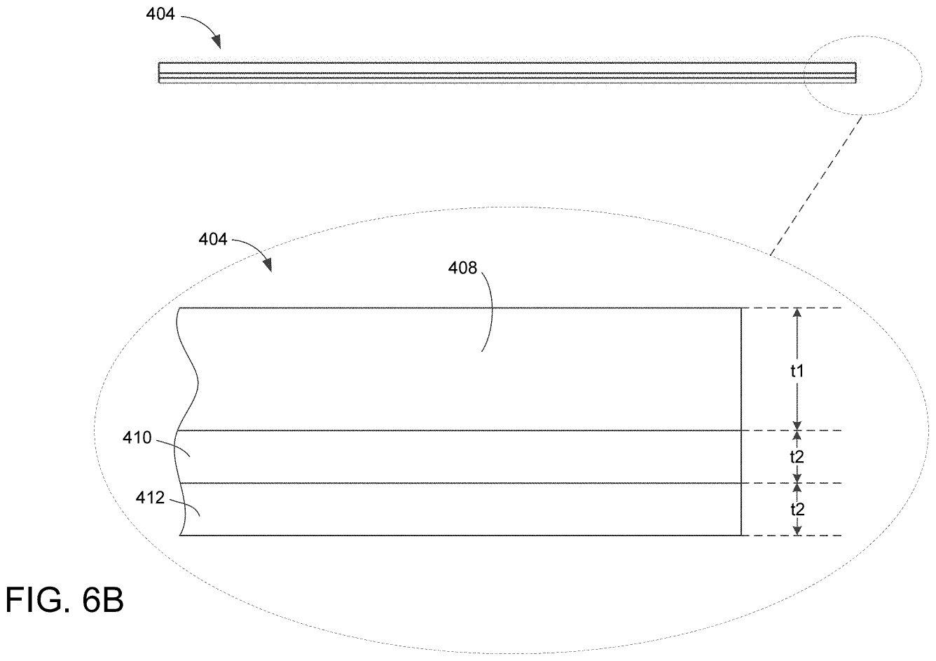

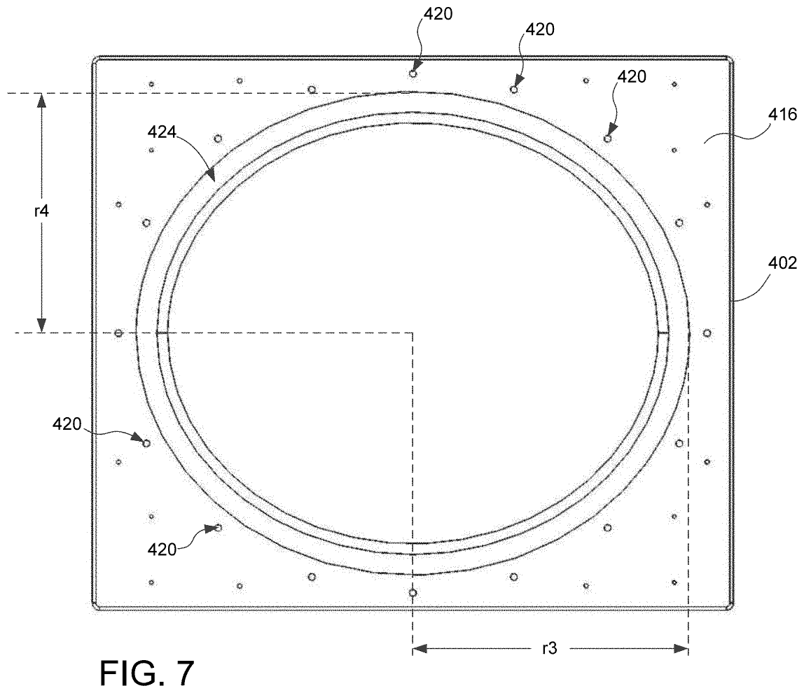

Referring to FIG. 6A, in some instances, elliptical ring component assembly 404 includes a plurality of apertures 418. The plurality of apertures 418 may be disposed approximately equidistantly around a perimeter and through elliptical ring component assembly 404. Each of the plurality of apertures 418 depicted in FIG. 6A represent corresponding aligning apertures through each of top plate 408, first gasket 410, and second gasket 412. Referring to FIG. 7, base plate 402 may include apertures 420 which are disposed through surface 416 of base plate 402 and are arranged about surface 416 such that apertures 418 of elliptical ring component assembly 404 may be aligned with apertures 420 of base plate 402.

Moreover, materials to be tested by materials testing apparatus 400 may be provided with an aperture or hole pattern (not shown) that matches or otherwise corresponds to the pattern of apertures 418, 420. In this way, when material to be tested is inserted between the first gasket 410 and second gasket 412, the material is aligned such that the apertures 418, 420 of elliptical ring component assembly 404 and base plate 402 align with the apertures of the material and securing elements are disposed through apertures 418, 420 and the apertures of the material to secure and seal the materials to base plate 402. It is to be appreciated that first gasket 410 and second gasket 412 are configured such that when the material is inflated while secured to base plate 402 (as described in greater detail below), the material is allowed to stretch without undergoing localized deformation/tearing at the edges where the material meets first gasket 410 and second gasket 412.

In some instances, elliptical ring component assembly 404 may comprise a single elliptical element for securing material to be tested to the base plate 402 and forming a seal. For instance, the single elliptical element may be a hybrid of top plate 408 and first gasket 410, and second gasket 412 may be integrated with, embedded in and/or bonded to surface 416 of base plate 402. This hybrid elliptical element may be configured with the same dimensions and properties described with respect to top plate 408, first gasket 410, and/or second gasket 412 below.

Referring again to FIG. 4, the base plate 402 includes at least one port or inlet 414 for receiving a gas from a gas source. For example, port 414 may be a connector configured to receive a tube (or a corresponding connector thereof) for exchanging gas with a gas source.

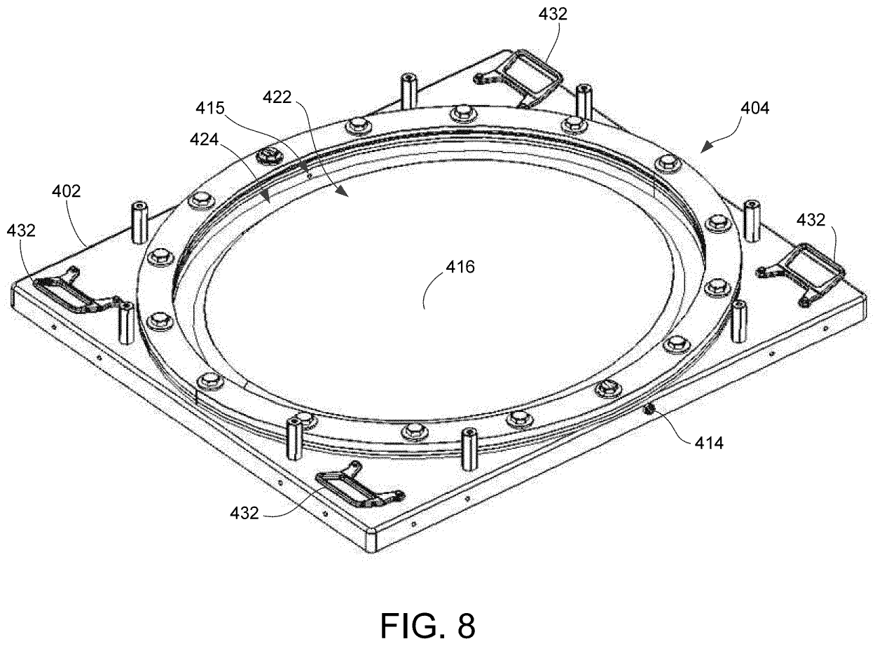

FIG. 8 provides a perspective view of materials testing apparatus 400 with containment plate 406 removed. When material to be tested is secured between the first gasket 410 and second gasket 412, gas may be received via port 414 of base plate 402 and provided to the area 422 contained by elliptical ring component assembly 404 between the material and surface 416 of base plate 402 to inflate the material. In some instances, materials testing apparatus 400 includes a second port 415 (shown in FIG. 8) disposed on an opposing side of base plate 402 relative to port 414. Port 415 may be configured in the same manner as port 414 including with respect to the placement of port 414 relative to base plate 402 and elliptical slot 424, described below. In some instances, port 415 may be used as a pressure check outlet. For example, a pressure gauge or other pressure sensor may be connected to port 415 to monitor the pressure being applied to the material in the inflated state. Moreover, port 415 may serve as an outlet for depressurizing the materials testing apparatus. In some instances, port 414 may also serve as an outlet for depressurizing the apparatus.

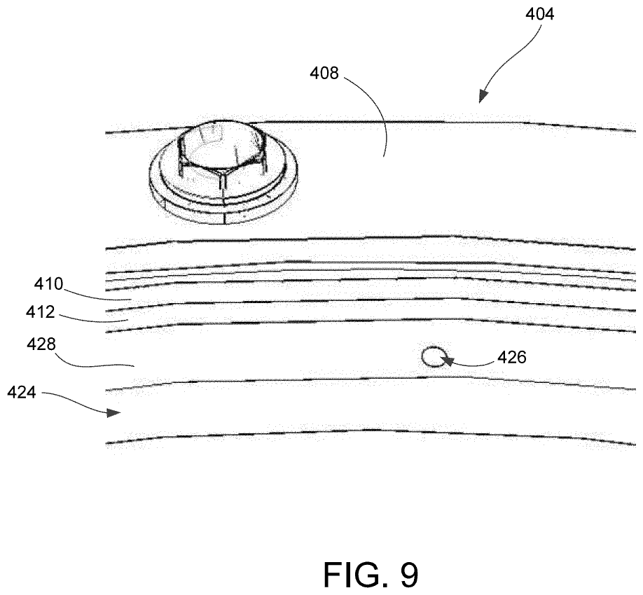

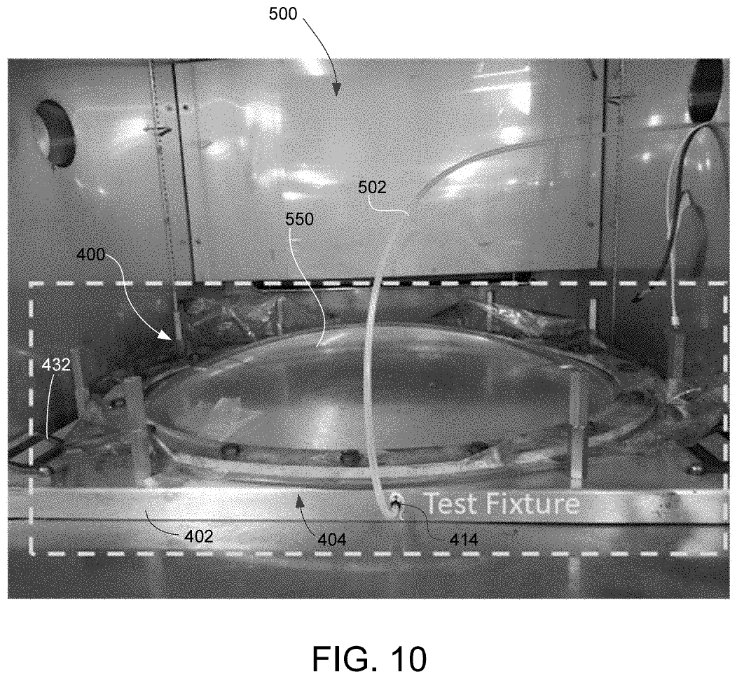

In some instances, base plate 402 includes an elliptical slot 424 disposed through surface 416 of base plate 402 and having an inner and outer perimeter or circumference. As such, gas provided to port 414 of base plate 402 may be provided to the elliptical slot 424 to inflate the material. For example, referring to FIG. 9, a channel 426 of port 414 extends through an inner surface 428 of base plate 402 to provide gas to channel 426 and to elliptical slot 424. As shown in FIG. 8, the elliptical slot 424 may be dimensioned such that the outermost elliptical perimeter of the elliptical slot 424 is approximately equivalent in proportion to the innermost perimeters of each of the top plate 408, first gasket 410, and second gasket 412. In other words, the outer most major and minor radii (labelled as r3 and r4 respectively in FIG. 7) of the elliptical slot 424 may be approximately equivalent to the inner most major and minor radii (labelled as r1 and r2 in FIG. 6A) of the top plate 408, first gasket 410, and second gasket 412.

The elliptical slot 424 provides several advantages with respect to the performance of materials testing apparatus 400. For example, the inclusion of elliptical slot 424 may enable a sufficiently large thickness of base plate 402 in the portion of base plate 402 contained between the inner perimeter of elliptical slot 424 to be used while also enabling channel 426 of port 414 to provide gas to inflate the material secured to base plate 402 by elliptical ring component assembly 404. The increased thickness of base plate 402 (than would otherwise be possible without the inclusion of elliptical slot 424) may be beneficial for countering deformation of the center of base plate 402 when the material is inflated and base plate 402 is subjected to the large levels of pressure that are required to test the material.

Referring again to FIG. 4, in some instances, the materials testing apparatus 400 includes a containment plate 406 and a plurality of posts 430 configured to attach the containment plate 406 to the base plate 402 using securing elements. In this arrangement, the containment plate 406 is disposed at a predetermined fixed distance from the base plate 402 and elliptical ring component assembly 404. The containment plate 406 is configured such that, should the material fail, such as by popping, tearing, etc. during testing while in the inflated and pressurized state, the containment plate 406 may contain any projected pieces of the material.

Moreover, in some instances, the materials testing apparatus 400 includes one or more handles 432 attached to the base plate 402, for example at the surface 416 for ease of handling and transporting the materials testing apparatus 400.

Referring to FIG. 10, materials testing apparatus 400 is shown testing a material 550 in a temperature-controlled environment 500. As shown in FIG. 10, during evaluation of the material 550 using the materials testing apparatus 400, the material 550 and materials testing apparatus 400 are placed in a temperature chamber, such as a temperature-controlled environment 500, that may subject the material 550 to a predetermined temperature range. This predetermined temperature range may be, for example, a range of −40 to 22 Celsius, or some other range of temperatures that an envelope, such as envelope 202 or envelope 252, of an LTA craft would be subject to during deployment.

Furthermore, pressurized gas may be provided to port 414 to inflate the secured and sealed portion of material 550 to a predetermined pressure thereby creating a bulge or blister in the material 550 shown in FIG. 10. For example, in some instances, the predetermined pressure may be in a range of, e.g., 70-90 kPa. The gas may be provided to port 414 via a tube 502 coupled at one end to port 414 and at the other end to a gas source. After material 550 is inflated as shown in FIG. 10 to the predetermined pressure, the stress state of the material 550 can be analyzed through the predetermined temperature range. It is to be appreciated that, during testing, the material may be inflated up to the predetermined pressure for each one of a number of selected temperatures within the predetermined temperature range that the temperature in environment 500 is held to. For example, in some instances, the selected temperatures within the predetermined temperature range may be −40 Celsius, −18 Celsius, and 22 Celsius, or more or less. However, many different temperatures may be selected from within the predetermined temperature range. In this way, materials testing apparatus 400 is used to evaluate the stress state and burst pressure of the material at the predetermined pressure at each one of the selected temperatures in the predetermined temperature range.

The analysis performed using materials testing apparatus 400 may provide as outputs the maximum vertical displacement of the inflated material (the bubble height) and the burst pressure. The bubble height may be used to verify certain material properties. Moreover, the analysis performed may provide the stress of the material, which when multiplied by the thickness may provide the stress in N/m and N/in. This maximum stress in N/m or N/in value may then be compared to uniaxial strengths for the material. In addition, the burst pressure determined during testing using materials testing apparatus 400 may be compared to a pressure predicted from analysis (i.e., a pressure at which the stressed in N/m, N/in exceed failure strengths). One objective of the analysis using materials testing apparatus 400 is to ensure the maximum stress ratio that the materials testing apparatus 400 imparts onto the material when inflated. The testing using the materials testing apparatus 400 provides biaxial strength of the material tested.

It is to be appreciated that the materials to be tested by materials testing apparatus 400 may have different characteristics in terms of stiffness and strength in different directions. For example, due to manufacturing processes, a material may include warp and weft directions, where in the warp direction the material is stiffer that in the weft direction. The elliptical shape and selected major and minor radii of elliptical ring component assembly 404 may enable materials testing apparatus 400 to impart a specific stress ratio in the warp and weft directions of material when the material is inflated to the predetermined pressure. For example, in some instances, during testing, the material may be oriented such that the warp direction of the material is aligned with the major radius (r1) of the elliptical ring component assembly 404 and the weft direction of the material is aligned with the minor radius (r2) of the elliptical ring component assembly 404 to impart the specific stress ratio.

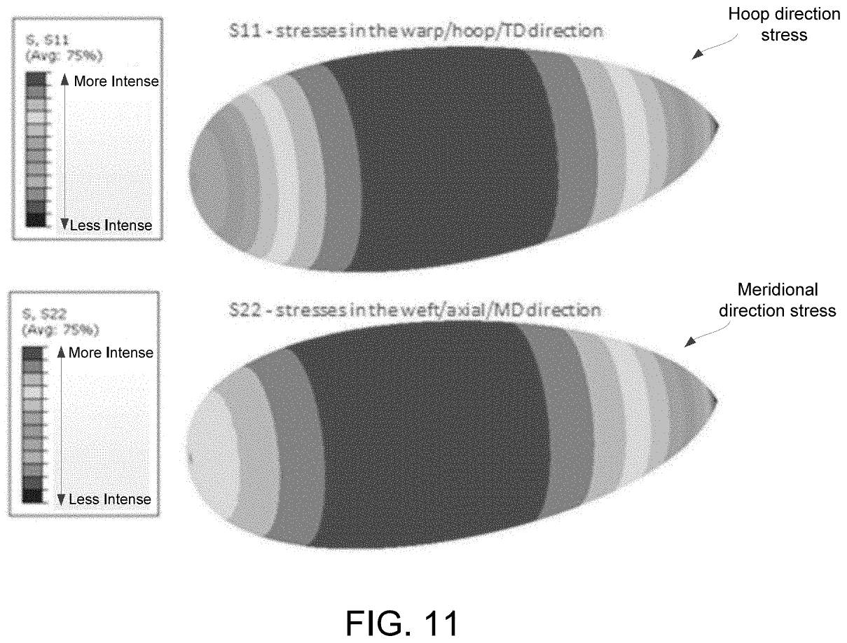

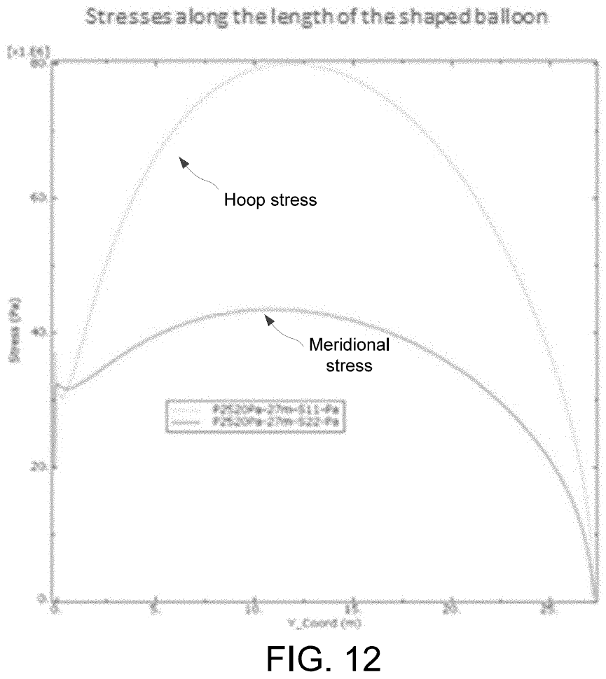

As discussed above, the material that materials testing apparatus 400 is configured to test may be used to manufacture shaped envelopes, such as envelopes 202, 250, for use in LTA crafts deployable in the stratosphere for long durations of time. Given the shape of an envelope made of the material, the maximum stress ratio for the material of the envelope is approximately 2:1 between the hoop and meridional directions of the material. It is to be appreciated that the stress ratio may vary based on envelope shape and type of material. The stress ratio may be any ratio greater than 1:1, for example, 1.5:1, 3:1, 4:1, etc. The maximum stress ratio is typically near the center of the envelope, lengthwise. For example, FIG. 11 illustrates the stresses in the hoop direction and the meridional direction along a length of an envelope of an airship or dirigible at different positions. FIG. 12 provides a chart showing the stresses along the length of the envelope in the hoop and meridional directions. The stresses along the length of the envelope in the hoop and meridional directions are represented by the x-axis of the chart in FIG. 12. The longitudinal positions that the stresses are assessed at along the length of the envelope in the hoop and meridional directions are represented by the y-axis of the chart in FIG. 12. FIGS. 11 and 12 demonstrate that at the center of the envelope, the material experiences a maximum stress ratio between the hoop and meridional directions of approximately 2:1. As part of material qualification, in a lab setting, the material may be subjected to a similar stress state, or in this example, up to a stress ratio of approximately 2:1. During testing, this stress ratio should be maintained at different temperatures, for example, the temperatures selected from within the predetermined temperature range described above to test the material of the envelope under conditions that the material may be subjected to as a part of an LTA craft during deployment.

The materials testing apparatus 400 described herein may be able to test a material using sufficiently high pressures required to achieve a predetermined maximum stress ratio of, for example, approximately 2:1 through a predetermined range of temperatures of, for example, −40 to 22 Celsius associated with the use of the material as part of an envelope of an LTA craft during deployment. For example, the elliptical ring component assembly 404 includes a minor radius (r2) having a first predetermined length and a major radius (r1) having a second predetermined length. The first predetermined length and the second predetermined length may be selected to impart a stress ratio up to the predetermined maximum ratio onto the material secured by elliptical ring component assembly 404 through the predetermined temperature range when the material is inflated to a predetermined pressure. As described above, the predetermined pressure may be in a range of 70-90 kPa. In one instance, the inner major and minor radii (r1 and r2 in FIG. 6A) of the top plate 408, first gasket 410, and second gasket 412 are approximately (+/−10%) 0.35 and 0.4 meters (m), respectively.

It is to be appreciated that the dimensions of materials testing apparatus 400 other than the major and minor radii (r1 and r2) of elliptical ring component assembly 404 may be selected to withstand the pressures required to test the material without deforming or otherwise failing. Moreover, these dimensions may be selected to seal the material and prevent leakage of the gas inflating the material during testing. For example, in one instance, the width (labelled “w” in FIG. 6A) of each of top plate 408, first gasket 410, and second gasket 412 is 50 millimeters (mm). Furthermore, as shown in FIG. 6B, the thickness, t1, of top plate 408 is approximately 12.7 mm. The thickness of the first gasket 410 and the second gasket 412, each of which is labelled as t2 in FIG. 6B, are each approximately 0.25 inches in this example. The thickness of base plate 402 is selected to withstand the pressures required to test the material without deforming. By way of example, the thickness of the base plate at the thickest portions (the portions other than the elliptical slot 424) may be on the order of 1.5 inches, or more or less.

It is to be appreciated that the dimensions of the components of materials testing apparatus 400 described herein are exemplary and other dimensions sufficient for testing materials as described herein are contemplated to be within the scope of the present disclosure.

The dimensions provided herein may be selected as a result of testing a material for use in the manufacture of an envelope of the LTA craft using a materials testing apparatus 400 having the dimensions described above. For example, experiments were conducted using materials testing apparatus 400 to test materials including warp and weft directions.

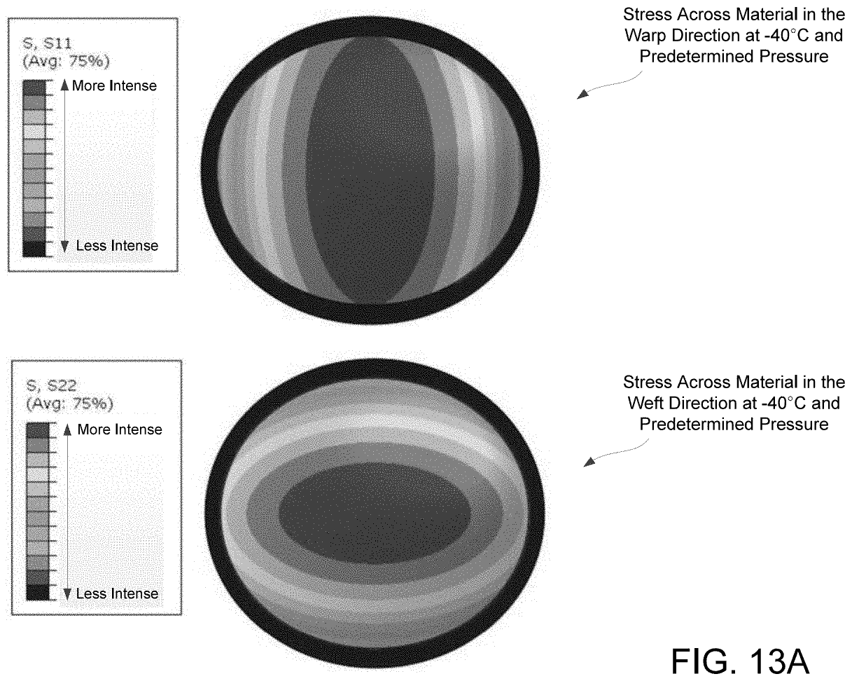

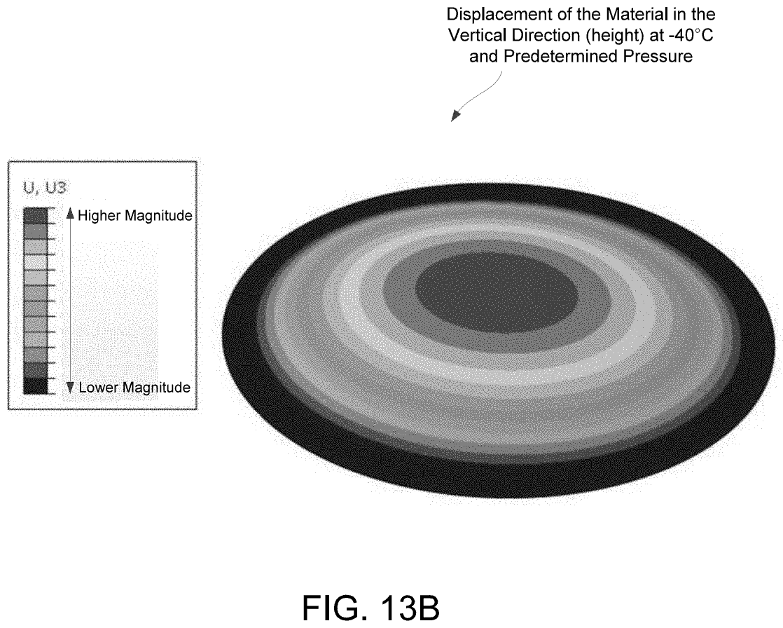

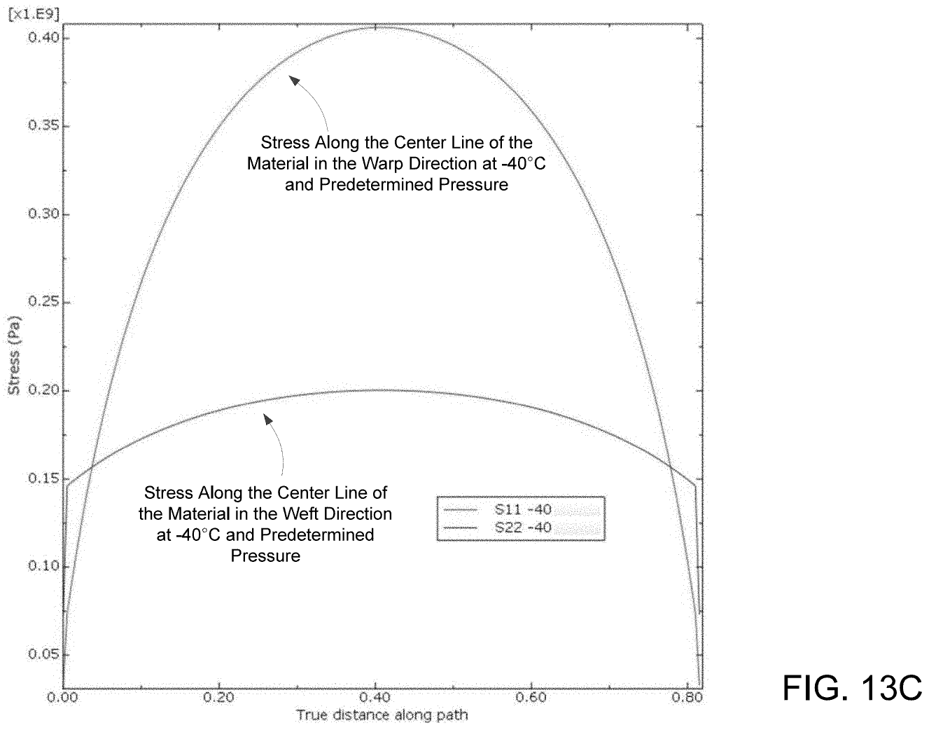

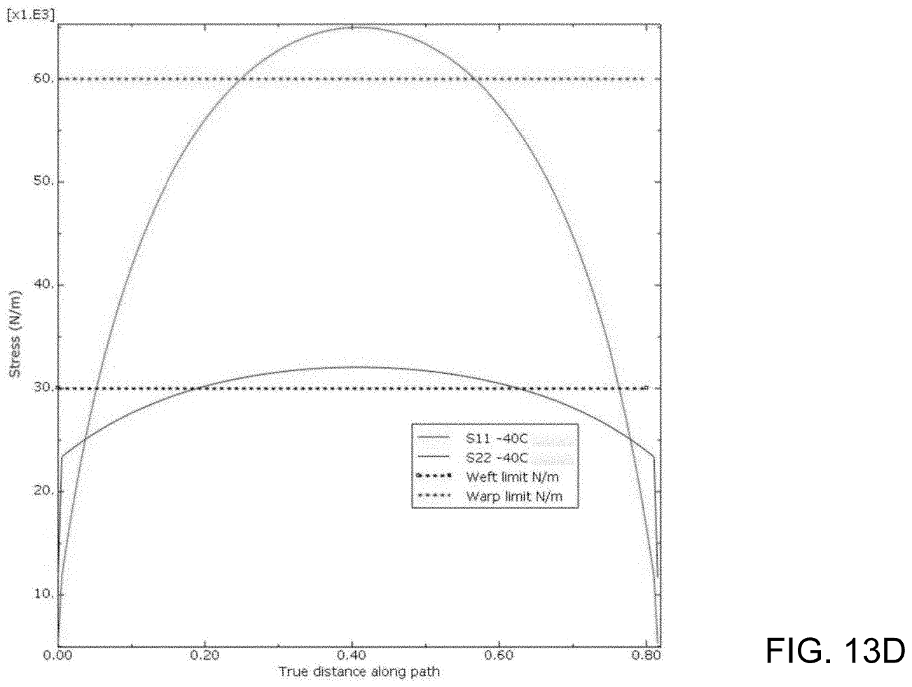

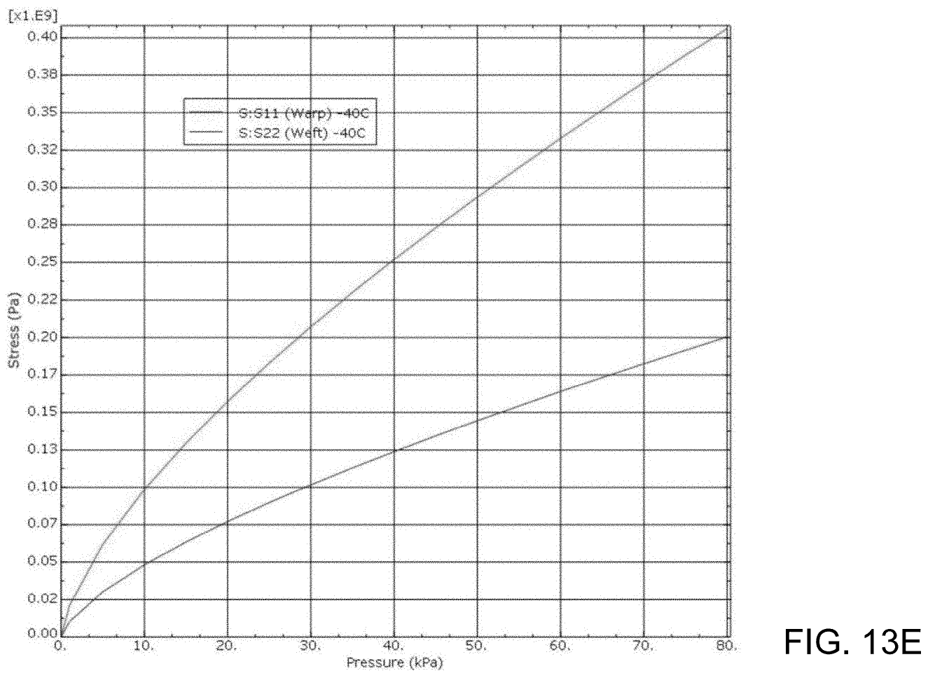

Referring to FIGS. 13A-13E, the results of tests using materials testing apparatus 400 to inflate a material to a predetermined pressure, such as in the range of 70-90 kPa in a controlled temperature environment, such as environment 500, held at −40 Celsius is shown. FIG. 13A shows the stresses across various positions of the material in the warp and weft directions at −40 Celsius and at the predetermined pressure. The colors shown in FIG. 13A indicate the stresses measured in Pa with the colors corresponding to the intensity (with red being the most intense and blue being the least intense) of the stress at different positions along the material. FIG. 13B shows the vertical displacement (indicated by color) across various positions of the material at −40 Celsius and the predetermined pressure. The colors shown in FIG. 13B indicate the displacement of the material measured in meters with the colors corresponding to the magnitude of the displacement (with red being the highest magnitude and blue being the lowest magnitude) of the material at different positions along the material. The vertical displacement in FIG. 13B may be the height as measured from surface 416 of base plate 402 that the material is raised or displaced. FIG. 13C shows a chart including the stresses along the center line of the material in the warp and weft directions at −40 Celsius and the predetermined pressure. In FIG. 13C, the y-axis represents stress measured in Pa and the x-axis represents distance in meters. FIG. 13D shows a chart including the stresses along the center line of the material (as shown in FIG. 13C) and the strength limits with respect to the warp and weft directions of the material. In FIG. 13D, the y-axis represents stress measured in N/m and the x-axis represents distance in meters. The strength limits in FIG. 13D are represented in dotted lines, where the red dotted line represents the warp direction and the blue dotted line represents the weft direction at −40 Celsius and the predetermined pressure. FIG. 13E provides a chart including the stresses of the material in the warp and weft directions at −40 Celsius and the predetermined pressure. The testing of the material using materials testing apparatus 400 at −40 Celsius and the predetermined pressure results in an approximate stress ratio of 2.026 between the warp and weft directions.

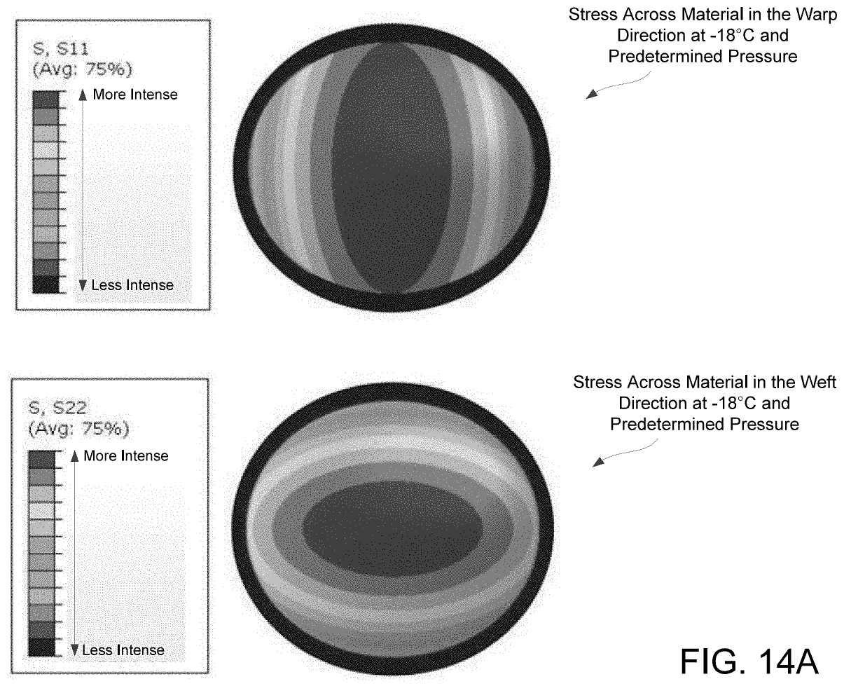

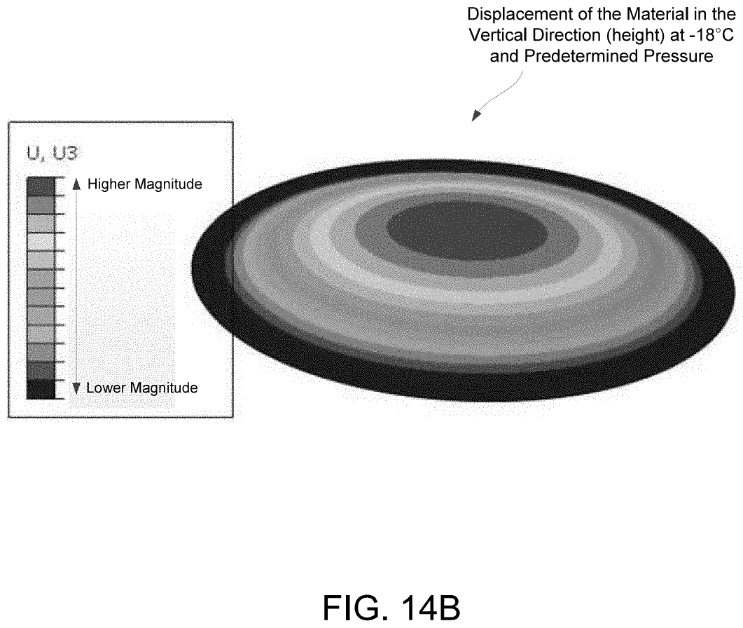

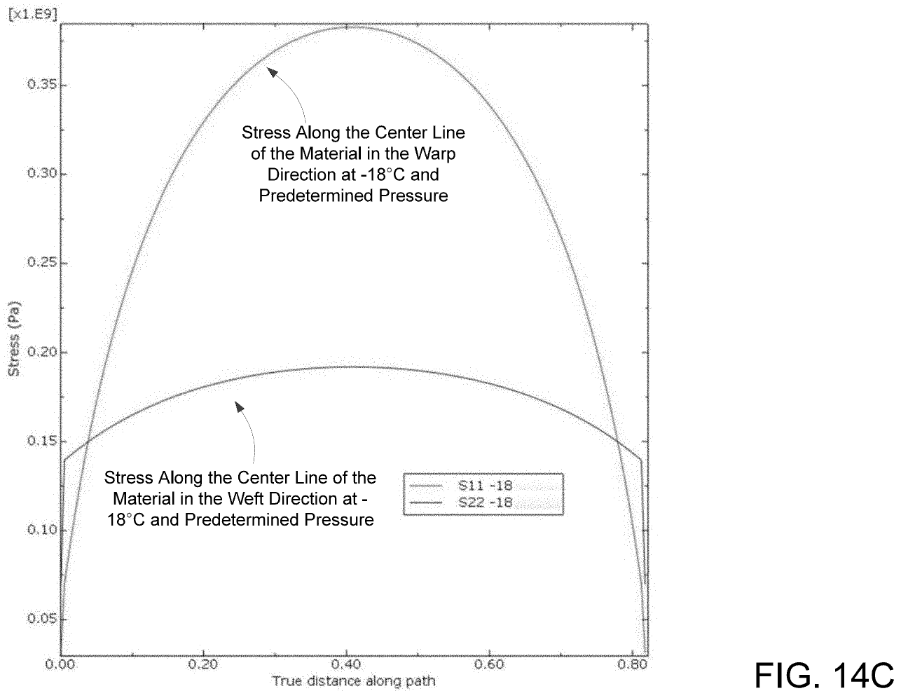

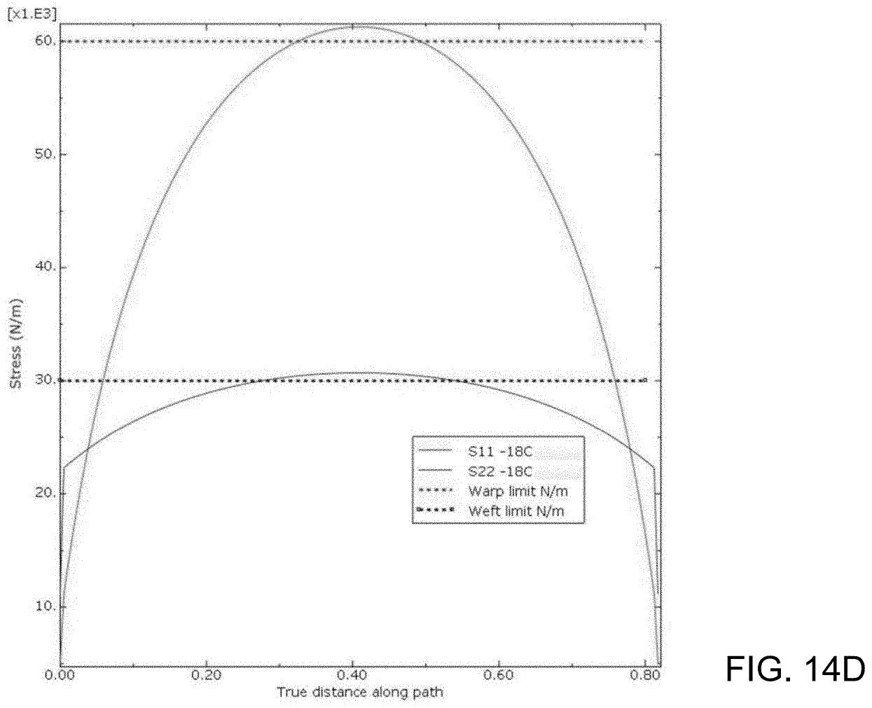

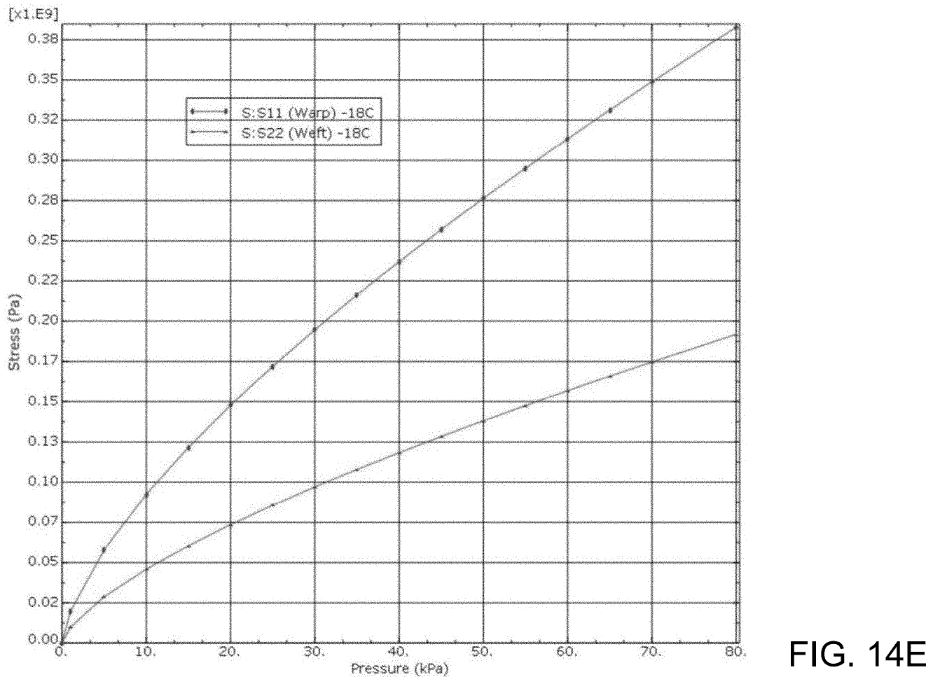

Referring to FIGS. 14A-14E, the results of tests using materials testing apparatus 400 to inflate a portion of a material to a predetermined pressure, such as in the range of 70-90 kPa in a controlled temperature environment, such as environment 500, held at −18 Celsius is shown. FIG. 14A shows the stresses across various positions of the material in the warp and weft directions at −18 Celsius and the predetermined pressure. The colors shown in FIG. 14A indicate the stresses measured in Pa with the colors corresponding to the intensity (with red being the most intense and blue being the least intense) of the stress at different positions along the material. FIG. 14B shows the vertical displacement (indicated by color) across various positions of the material at −18 Celsius and the predetermined pressure. The colors shown in FIG. 14B indicate the displacement of the material measured in meters with the colors corresponding to the magnitude of the displacement (with red being the highest magnitude and blue being the lowest magnitude) of the material at different positions along the material. The vertical displacement in FIG. 14B may be the height as measured from surface 416 of base plate 402 that the material is raised or displaced. FIG. 14C shows a chart including the stresses along the center line of the material in the warp and weft directions at −18 Celsius and the predetermined pressure. In FIG. 14C, the y-axis represents stress measured in Pa and the x-axis represents distance in meters. FIG. 14D shows a chart including the stresses along the center line of the material (as shown in FIG. 14C) and the strength limits with respect to the warp and weft directions of the material. In FIG. 14D, the y-axis represents stress measured in N/m and the x-axis represents distance in meters. The strength limits in FIG. 14D are represented in dotted lines, where the red dotted line represents the warp direction and the blue dotted line represents the weft direction at −18 Celsius and the predetermined pressure. FIG. 14E shows a chart including the stresses of the material in the warp and weft directions at −18 Celsius and the predetermined pressure. The testing of the material using materials testing apparatus 400 at −18 Celsius and the predetermined pressure results in an approximate stress ratio of 1.99 between the warp and weft directions.

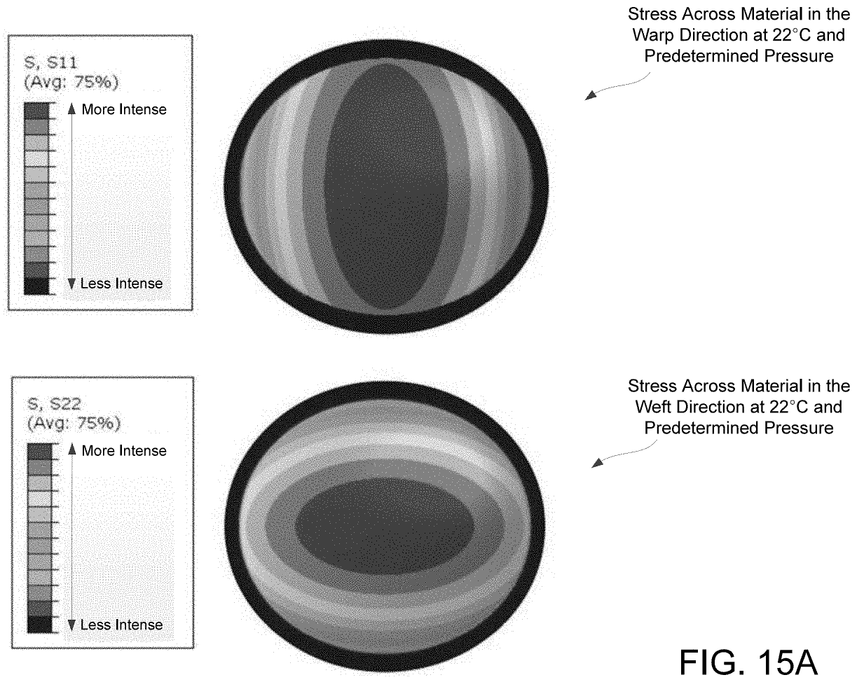

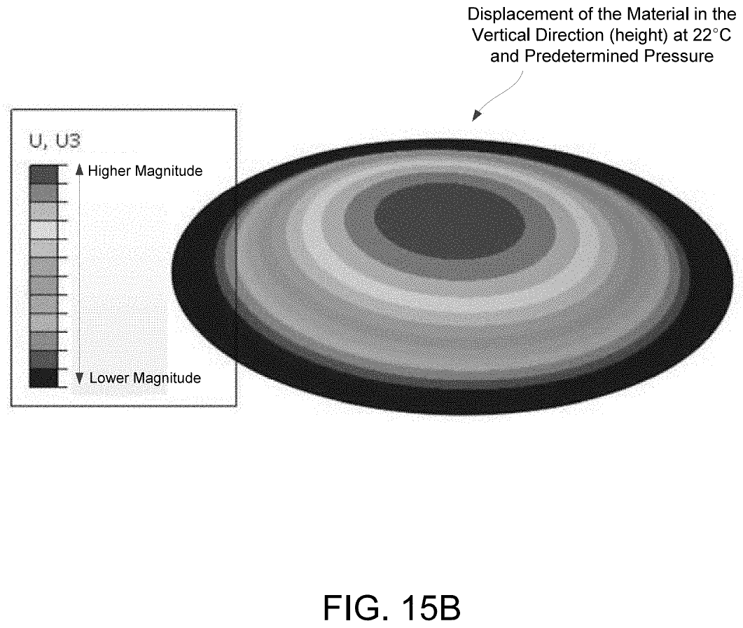

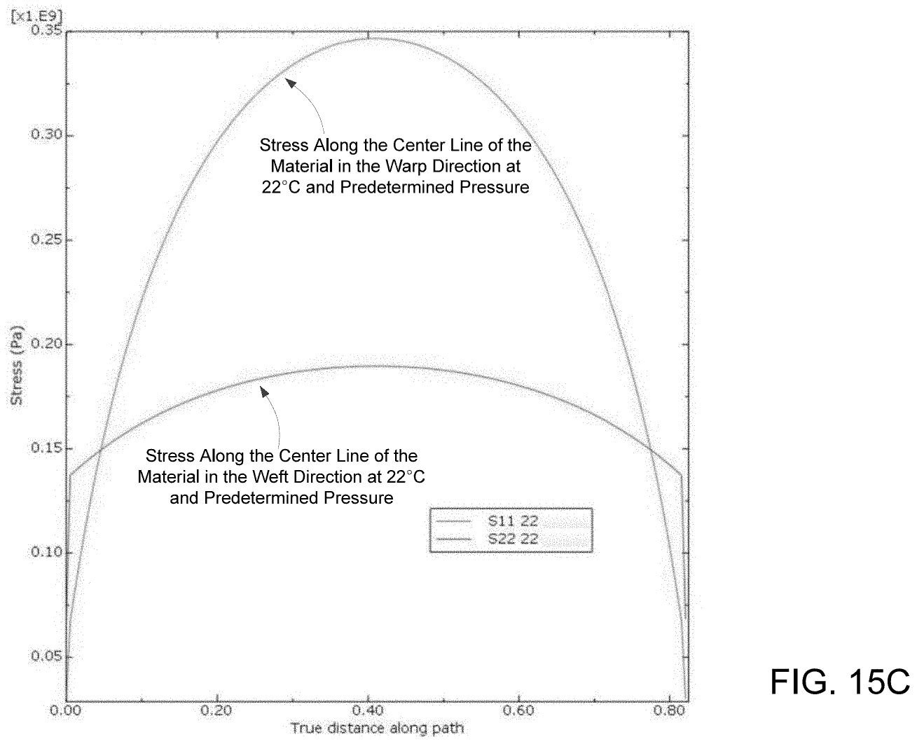

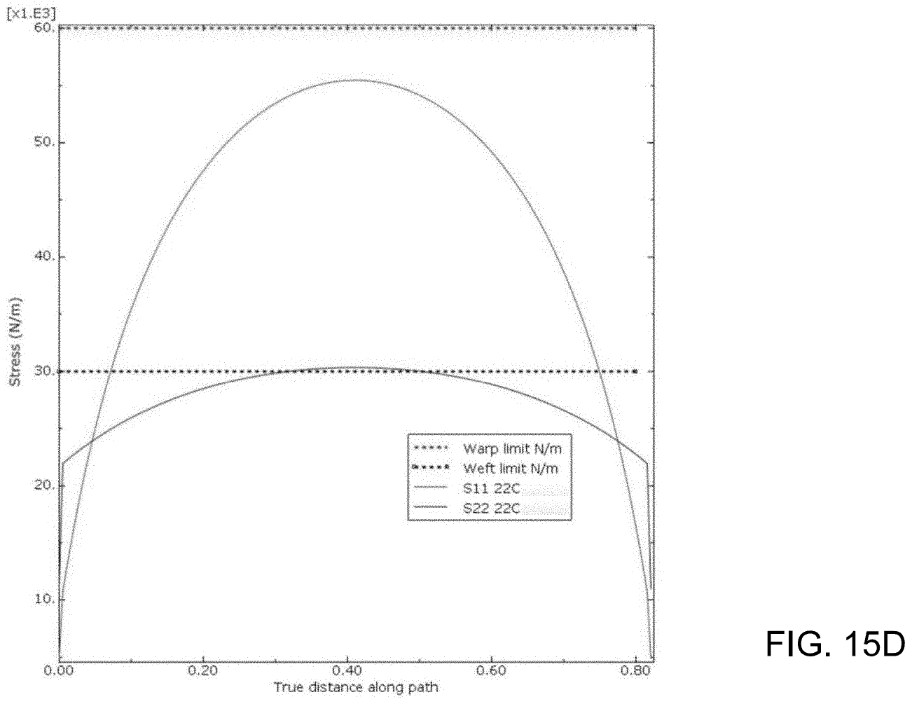

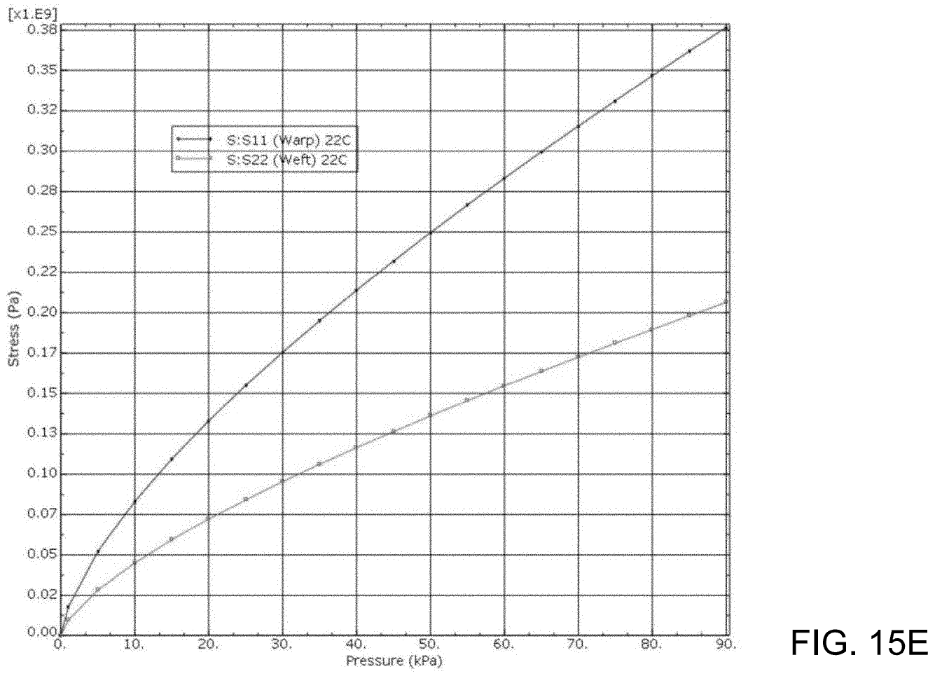

Referring to FIGS. 15A-15E, the results of tests using materials testing apparatus 400 to inflate a portion of a material to a predetermined pressure, such as in the range of 70-90 kPa in a controlled temperature environment, such as environment 500, held at 22 Celsius is shown. FIG. 15A shows the stresses across various positions of the material in the warp and weft directions at 22 Celsius and the predetermined pressure. The colors shown in FIG. 15A indicate the stresses measured in Pa with the colors corresponding to the intensity (with red being the most intense and blue being the least intense) of the stress at different positions along the material. FIG. 15B shows the vertical displacement in meters (indicated by color) across various positions of the material at 22 Celsius and the predetermined pressure. The colors shown in FIG. 15B indicate the displacement of the material measured in meters with the colors corresponding to the magnitude of the displacement (with red being the highest magnitude and blue being the lowest magnitude) of the material at different positions along the material. The vertical displacement in FIG. 15B may be the height as measured from surface 416 of base plate 402 that the material is raised or displaced. FIG. 15C shows a chart including the stresses along the center line of the material in the warp and weft directions at 22 Celsius and the predetermined pressure. In FIG. 15C, the y-axis represents stress measured in Pa and the x-axis represents distance in meters. FIG. 15D shows a chart including the stresses along the center line of the material (as shown in FIG. 15C) and the strength limits with respect to the warp and weft directions of the material. In FIG. 15D, the y-axis represents stress measured in N/m and the x-axis represents distance in meters. The strength limits in FIG. 15D are represented in dotted lines, where the red dotted line represents the warp direction and the blue dotted line represents the weft direction at 22 Celsius and the predetermined pressure. FIG. 15E shows a chart including the stresses of the material in the warp and weft directions at 22 Celsius and the predetermined pressure. The testing of the material using materials testing apparatus 400 at 22 Celsius and the predetermined pressure results in an approximate stress ratio of 1.83 between the warp and weft directions.

As the experimental results described above in relation to FIGS. 13A-15E show, the elliptical shape and dimensions of the elliptical ring component assembly 404 are selected such that, with the material oriented in the manner described above and inflated to the predetermined pressure, an approximate maximum stress ratio of 2:1 between the warp and weft directions is achieved throughout the temperature range of −40 to 22 Celsius. It is to be appreciated that the stress ratio while the material is inflated and subjected to the different temperatures may vary from approximately 1.83:1 to 2.026:1 (+/−10%). Thus, the desired maximum stress ratio of 2:1 is approximately maintained throughout the predetermined temperature range. The dimensions of the elliptical ring component assembly 404 are determined based on strength limits of the material in the warp and weft. For example, the strength limits of the material may be in a range of 1 kN/m to 100 kN/m with the strength limits having a predetermined ratio between the warp and weft directions, such as a maximum ratio of 2:1, in the warp and weft directions, respectively. The materials testing apparatus 400 may be used to test materials that exhibit anisotropy. Materials that have different stiffness/strengths in the warp and weft directions are examples of materials that exhibit anisotropy. Such materials may have certain strength limits in the warp and weft directions. Elliptical ring component assembly 404 and base plate 402 are designed to impart a sufficient maximum stress ratio onto the material without exceeding these strength limits.

In some instances, the first gasket 410 and second gasket 412 are configured from a material, such as silicone, having approximately (+/−10%) a 40A shore hardness. By way of example, the top plate 408 may be made of a metal, such as aluminum, a carbon fiber composite and/or plastics. The carbon fiber composite may comprise a fiber layup composite, short fiber compressed composite, and/or any other carbon fiber composite. The plastics may be reinforced plastics. In any case, the material of the top plate 408 is selected to withstand the end cap forces generated when the material is inflated to high pressures, such as 70-90 kPa, during testing using materials testing apparatus 400.

The above-described material properties of the components of materials testing apparatus 400 are selected based on various experiments for testing the tolerances of the materials for use in conditions, such as pressures and temperatures, that tests using materials testing apparatus 400 will be performed under.

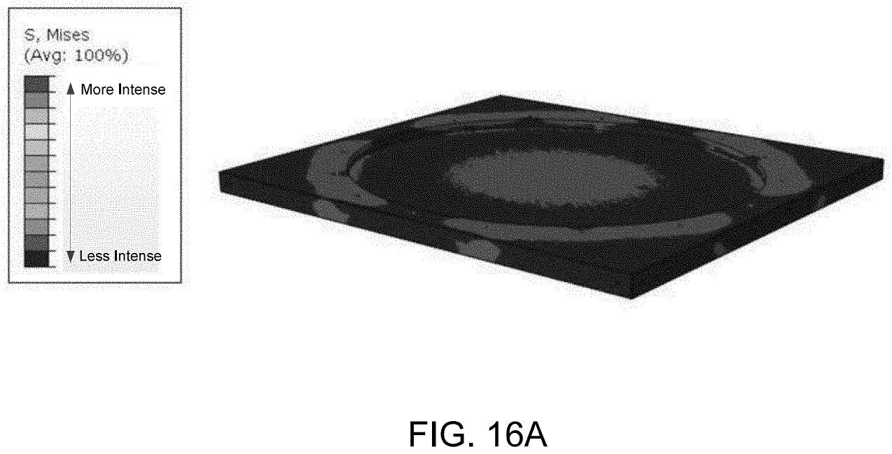

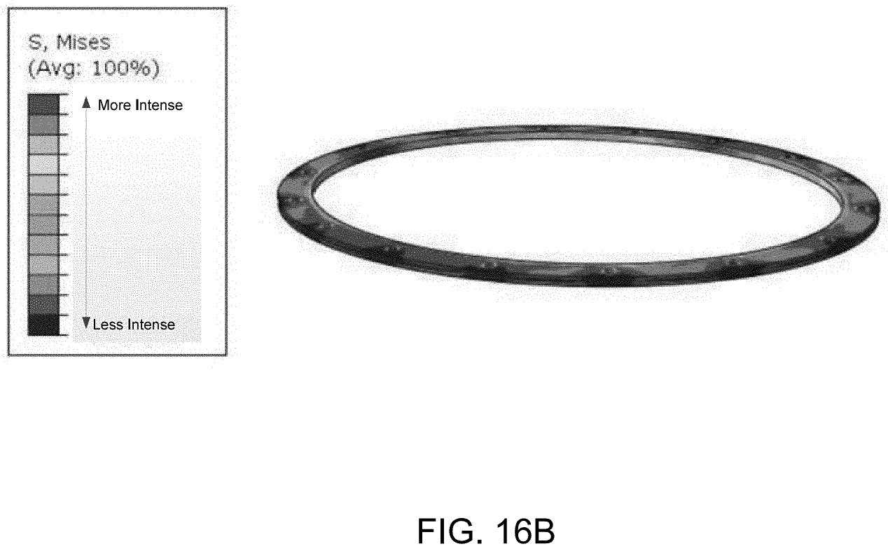

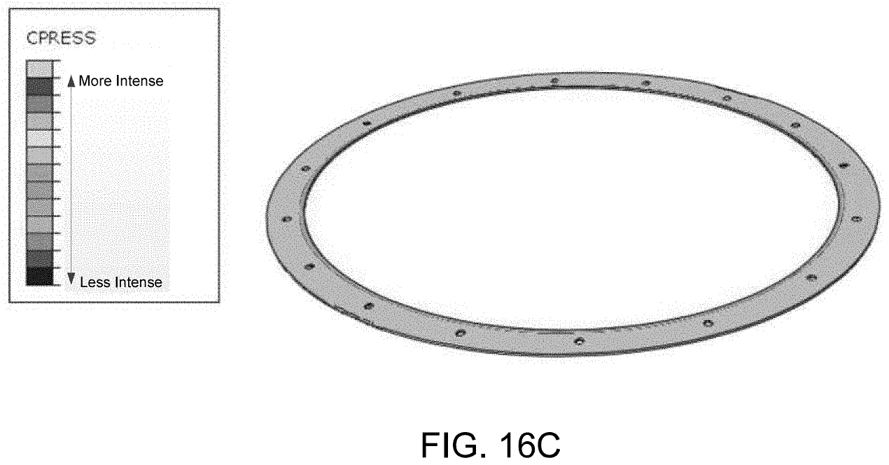

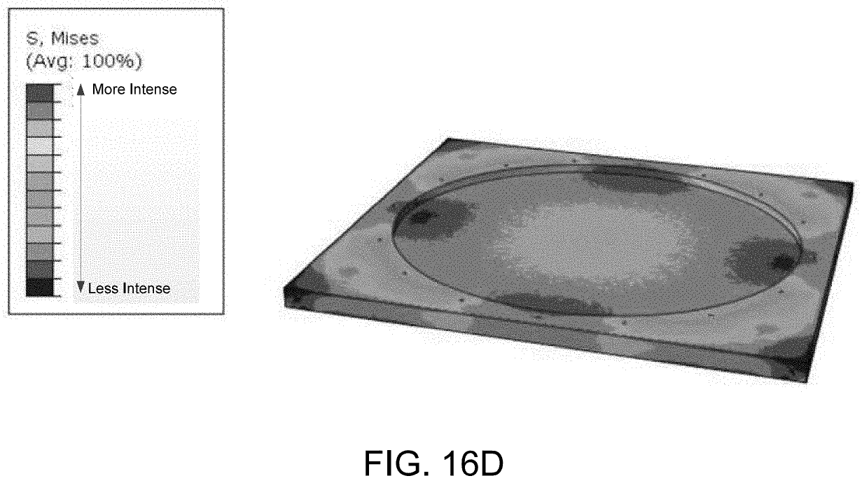

For example, FIG. 16A illustrates stress analysis of base plate 402 that shows that base plate 402 does not yield under high pressure, for example, in the range of 100-200 kPa. FIG. 16B illustrates stress analysis of top plate 408 that shows that top plate 408 does not yield under high pressure, for example, in the range of 100-200 kPa. The colors shown in FIGS. 16A and 16B represent Mises stresses with units of kPa. The colors shown in FIGS. 16A and 16B correspond to the magnitude or intensity (with red being the most intense and blue being the least intense) of the stress at various locations of base plate 402 in relation to the values shown.

FIG. 16C illustrates the contact pressure on gaskets 410, 412 when the material is inflated during use with materials testing apparatus 400. The units of the pressure in FIG. 16C are in kPa. The colors in FIG. 16C correspond to the magnitude or intensity of the contact pressure at various locations of the gaskets 410, 412. The analysis in FIG. 16C illustrates that gaskets 410, 412 experience contact pressure greater than the predetermined pressure applied to the material when inflated during testing, for example, where the predetermined pressure applied to the material is in the range of 70-90 kPa.

FIG. 16D illustrates stress analysis of base plate 402. The units of the stress in FIG. 16D are in kPa and the colors represent Mises stresses at various locations of base plate 402 (with red being the most intense and blue being the least intense). FIG. 16D shows that base plate 402 does not yield under pressures even higher than the predetermined pressure described above that the material is inflated to during testing. Thus, materials testing apparatus 400 will not fail during use when the material is inflated to the predetermined pressure.

In addition, the dimensions of the elliptical ring component assembly 404 may be calculated or determined as a function of the upper limit of pressure, stress state, and/or the temperature range desired for testing and the type of material or material being tested. The stress state may be a ratio between the stresses applied in the warp and weft direction of the material to be tested. For example, different materials used to make different envelopes or other shapes may require testing at different upper limit pressures and/or maximum stress ratios between the hoop and meridional or other directions (e.g., warp and weft) associated with a material through different predetermined temperature ranges. Thus, the above-described dimensions of elliptical ring component assembly 404 may be recalculated accordingly based on these characteristics of the type of material to be tested and the desired conditions under which the material may be used.

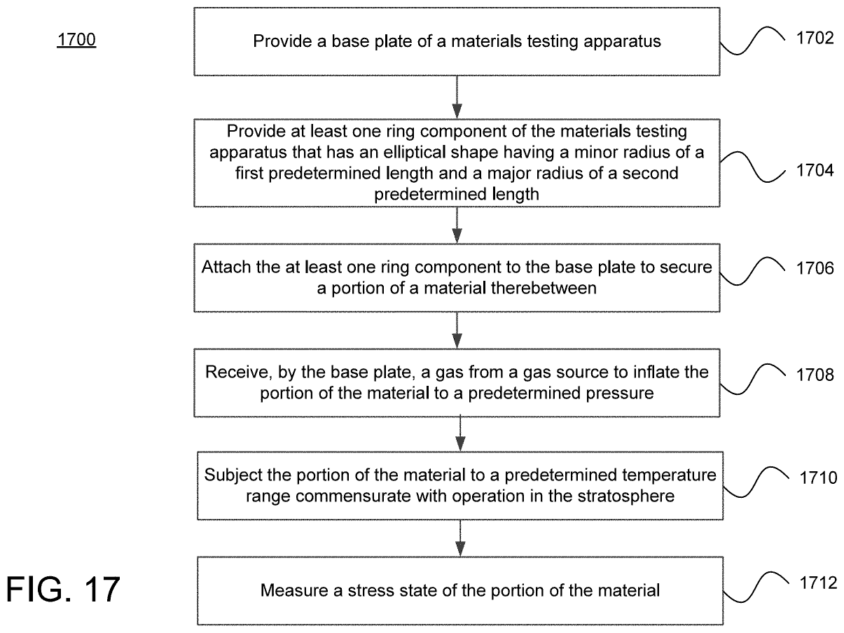

FIG. 17 illustrates a flow diagram of a method 1700 for testing a material for use in an LTA craft deployable in the stratosphere. Method 1700 may be used to test a material used to manufacture envelopes for LTA craft. Initially, in block 1702, the method provides a base plate of a materials testing apparatus, such as base plate 402 of materials testing apparatus 400 described above. In block 1704, the method provides at least one ring component configured in an elliptical shape having a minor radius with a first predetermined length and a major radius with a second predetermined length. For example, the at least one ring component may be one or more of top plate 408, first gasket 410 and/or second gasket 412 of materials testing apparatus 400 described above. The first predetermined length of the minor radius may be 0.35 m and the second predetermined length of the major radius may be 0.4 m. In block 1706, the at least one ring component is attached to the base plate to secure and seal a portion of a material to be tested therebetween. For example, the material may be attached in the manner described above in relation to materials testing apparatus 400. In block 1708, the base plate receives a gas, for example from a gas source via a port, such as port 414 of base plate 402, to inflate the portion of the material to a predetermined pressure. For example, the predetermined pressure may be a pressure in the range of 70-90 kPa. In block 1710, the portion of the material is subjected to a predetermined temperature range, such as, for example, −40 to 22 Celsius. And in block 1714, a stress state of the portion of the material is measured. As described above, the first predetermined length and the second predetermined length of the minor and major radii of the at least one ring component may be selected to impart a stress ratio up to a predetermined maximum stress ratio onto the portion of the material secured by the at least one ring component to the materials testing apparatus through the predetermined temperature range when the portion of the material is inflated to the predetermined pressure. For example, the predetermined maximum stress ratio is approximately 2:1.

The foregoing examples are not mutually exclusive and may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. An apparatus for testing a material for use in a lighter-than-air craft deployable in the stratosphere, the apparatus comprising:
a base plate; and
at least one ring component configured to attach to the base plate to secure a portion of the material during testing;
wherein:
the at least one ring component has an elliptical shape, the elliptical shape including a minor radius having a first predetermined length and a major radius having a second predetermined length,
the base plate is configured to receive gas to inflate and pressurize the portion of the material secured by the at least one ring component, and
the first predetermined length and second predetermined length are selected to impart a stress ratio up to a predetermined maximum ratio onto the portion of the material secured by the at least one ring component through a predetermined temperature range when the portion of the material is inflated to a predetermined pressure.

2. The apparatus of claim 1, wherein the first predetermined length is approximately 0.35 meters and the second predetermined length is approximately 0.4 meters.

3. The apparatus of claim 1, wherein the material includes warp and weft directions and the first predetermined length and the second predetermined length are selected based on strength limits in the warp and weft directions, respectively, of the material.

4. The apparatus of claim 1, wherein the predetermined maximum ratio is a ratio between a strength limit of the material in a first direction of the material and a strength limit of the material in a second direction of the material.

5. The apparatus of claim 4, wherein the first direction is a warp direction of the material and the second direction is a weft direction of the material.

6. The apparatus of claim 1, wherein the predetermined maximum ratio is approximately 2:1.

7. The apparatus of claim 1, wherein the predetermined maximum ratio corresponds to a stress state that the lighter-than-air craft is subjected to during deployment.

8. The apparatus of claim 1, wherein the predetermined temperature range corresponds to a temperature range the lighter-than-air craft is expected to be exposed to during deployment.

9. The apparatus of claim 8, wherein the predetermined temperature range is between −40 Celsius to 22 Celsius.

10. The apparatus of claim 1, wherein the at least one ring component comprises first and second gaskets and the portion of the material is compressed between the first and second gaskets to prevent leakage of the gas inflating and pressurizing the portion of the material.

11. The apparatus of claim 10, wherein the at least one ring component further comprises an elliptical ring configured to attach the first and second gaskets to the base plate.

12. The apparatus of claim 1, further comprising a containment plate attached to and disposed a predetermined distance from the at least one ring component and opposite the base plate.

13. A method for testing a material for use in a lighter-than-air craft deployable in the stratosphere, the method comprising:
providing a base plate of a materials testing apparatus;
providing at least one ring component of the materials testing apparatus that has an elliptical shape, the elliptical shape including a minor radius having a first predetermined length and a major radius having a second predetermined length;
attaching the at least one ring component to the base plate to secure a portion of the material therebetween;
receiving, by the base plate, a gas from a gas source to inflate the portion of the material to a predetermined pressure;
subjecting the portion of the material to a predetermined temperature range commensurate with operation in the stratosphere, wherein the first predetermined length and second predetermined length are selected to impart a stress ratio up to a predetermined maximum ratio onto the portion of the material secured by the at least one ring component through the predetermined temperature range when the portion of the material is inflated to the predetermined pressure; and
measuring a stress state of the portion of the material.

14. The method of claim 13, wherein the first predetermined length is approximately 0.35 meters and the second predetermined length is approximately 0.4 meters.

15. The method of claim 13, wherein the material includes warp and weft directions and the first predetermined length and the second predetermined length are selected based on strength limits in the warp and weft directions, respectively, of the material.

16. The method of claim 13, wherein the predetermined maximum ratio is a ratio between a strength limit of the material in a first direction of the material and a strength limit of the material in a second direction of the material.

17. The method of claim 16, wherein the first direction is a warp direction of the material and the second direction is a weft direction of the material.

18. The method of claim 13, wherein the predetermined maximum ratio is approximately 2:1.

19. The method of claim 13, wherein the predetermined maximum ratio corresponds to a stress state that the lighter-than-air craft is subjected to during deployment.

20. The method of claim 13, wherein the predetermined temperature range corresponds to a temperature range the lighter-than-air craft is exposed to during deployment.

21. The method of claim 20, wherein the predetermined temperature range is between −40 Celsius to 22 Celsius.

22. The method of claim 13, wherein the at least one ring component comprises first and second gaskets and the portion of the material is compressed between the first and second gaskets to prevent leakage of the gas inflating and pressurizing the portion of the material.

23. The method of claim 22, wherein the at least one ring component further comprises an elliptical ring configured to attach the first and second gaskets to the base plate.

24. The method of claim 13, further comprising attaching a containment plate to the materials testing apparatus so that the containment plate is disposed a predetermined distance from the at least one ring component and opposite the base plate.
